(19) United States
(12) Patent Application Publication
(10) Pub. No.: US 2007/0121623 A1
(43) Pub. Date: May 31, 2007

(54) Method and system for establishing narrowband communications connections using virtual local area network identification

(76) Inventors: Jose A. Garcia, Frisco, TX (US); James J. Gainer, Keller, TX (US); Stephen L. Jenkins, Prosper, TX (US); Jack C. Wybenga, Plano, TX (US); Leslie R. Murray, Euless, TX (US); David Desai, Plano, TX (US); Harry Hartjes, Plano, TX (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/508,751

(22) Filed: Aug. 23, 2006

Related U.S. Application Data
(63) Continuation-in-part of application No. 11/291,483, filed on Nov. 30, 2005.
(60) Provisional application No. 60/755,020, filed on Dec. 29, 2005.

(51) Int. Cl. H04L 12/56

(52) U.S. Cl. 370/389

(57) ABSTRACT

A method and system detects a network connection in a communications system, such as a narrowband communications system, using Virtual Local Area Network (VLAN) identification. In one embodiment, a first node transmits a message to a specific second node among a group of second nodes. The message from the first node includes a source Medium Access Control (MAC) address, a broadcast address, and a unique VLAN identification corresponding to a port on the first node. The specific second node processes the message, and then transmits its own MAC address to the first node, along with the unique VLAN identification received in the original message from the first node. The first node then updates stored information about the second node and uses the information in future communications to the second node.

### RELATED APPLICATIONS

This application is a continuation-in-part of U.S. application ser. No. 11/291,483 filed Nov. 30, 2005. This application also claims the benefit of U.S. application Ser. No. 60/755,020, filed Dec. 29, 2005. The entire teachings of the above applications are incorporated herein by reference.

### BACKGROUND OF THE INVENTION

Prior to growth in the public's demand for data services, such as dial-up Internet access, existing local loop access networks transported mostly voice information. In telephony, a local loop is defined as a wired connection from a telephone company's central office (CO) to its subscribers' telephones at homes and businesses. This connection is usually based on a pair of copper wires, typically in the form of twisted-pair wires. An existing access network typically includes numerous twisted-pair wire connections between a plurality of user locations and a central office switch (or terminal). These connections can be multiplexed in order to transport voice calls more efficiently to and from the central office. The existing access network for the local loop is designed to carry these voice signals, i.e., it is a voice-centric network.

Today, data traffic carried across telephone networks is growing exponentially, and, by many measures, may have already surpassed traditional voice traffic, due in large measure to an explosive growth of dial-up data connections. The basic problem with transporting data over this voice-centric network, and, in particular, the local loop access part of the network, is that it is optimized for voice traffic, not data. The voice-centric structure of the access network limits an ability to receive and transmit high-speed data signals along with traditional quality voice signals. Simply put, the access part of the existing access network is not well-matched to the type of information it is now primarily transporting. As users demand higher and higher data transmission capabilities, the inefficiencies of the existing access network will cause user demand to shift to other mediums of transport for fulfillment, such as satellite transmission, cable distribution, wireless services, etc.

An alternative existing local access network that is available in some areas is a digital loop carrier (DLC). DLC systems utilize fiber-optic distribution links and remote multiplexing devices to deliver voice and data signals to and from the local users. In a typical DLC system, a fiber optic cable is routed from the central office terminal (COT) to a host digital terminal (HDT) located within a particular neighborhood. Telephone lines from subscriber homes are then routed to circuitry within the HDT, where the telephone voice signals are converted into digital pulse-code modulated (PCM) signals, multiplexed together using a time-slot interchanger (TSI), converted into an equivalent optical signal, and then routed over the fiber optic cable to the central office. Likewise, telephony signals from the central office are multiplexed together, converted into an optical signal for transport over the fiber to the HDT, converted into corresponding electrical signals at the HDT, demultiplexed, and routed to the appropriate subscriber telephone line twisted-pair connection.

Some DLC systems have been expanded to provide so-called Fiber-to-the-Curb (FTTC) systems. In these systems, the fiber optic cable is pushed deeper into the access network by routing fiber from the HDT to a plurality of Optical Network Units (ONUs) that are typically located within 500 feet of a subscriber's location. Multi-media voice, data, and even video from the central office location is transmitted to the HDT. From the HDT, these signals are transported over the fibers to the ONUs, where complex circuitry inside the ONUs demultiplexes the data streams and distributes the voice, data, and video information to the appropriate subscriber.

These prior art DLC and FTTC systems suffer from several disadvantages. First, these systems are costly to implement and maintain due to a need for sophisticated signal processing, multiplexing/demultiplexing, control, management and power circuits located in the HDT and the ONUs. Purchasing, then servicing this equipment over its lifetime has created a large barrier to entry for many local loop service providers. Scalability is also a problem with these systems. Although these systems can be partially designed to scale to future uses, data types, and applications, they are inherently limited by the basic technology underpinning the HDT and the ONUs. Absent a wholesale replacement of the HDT or the ONUs (a very costly proposition), these DLC and FTTC systems have a limited service life due to the design of intermediate electronics in the access loop.

### SUMMARY OF THE INVENTION

According to an embodiment of the present invention, a method and system detects a network connection in a communications system, such as a narrowband communications system, using Virtual Local Area Network (VLAN) identification. In one embodiment, a first node transmits a message to a specific second node among a group of second nodes. The message from the first node includes a source Medium Access Control (MAC) address, a broadcast address, and a unique VLAN identification corresponding to a port on the first node. The specific second node processes the message, and then transmits its own MAC address to the first node, along with the unique VLAN identification received in the original message from the first node. The first node then updates stored information about the second node.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a network including a system in which an embodiment of the present invention may be deployed;

FIG. 2 is a more detailed diagram of network of FIG. 1 including components of a remote digital terminal and an optical networking unit according to an embodiment of the present invention;

FIG. 3 is a detailed block diagram of a host digital terminal and an optical networking unit of FIG. 2 according to an embodiment of the present invention;

FIG. 4 is a detailed block diagram of internal system interfaces of a remote digital terminal and an optical networking unit of FIG. 2 incorporating redundant Ethernet Switch Units according to an embodiment of the present invention;

FIG. 5 is a functional block diagram of an Ethernet Switch Unit (ESU) of FIGS. 2,3 and 4.

FIG. 6 is a functional block diagram of a Quadrature (Quad) Optical Interface Unit (QOIU) of FIGS. 2, 3 and 4.

FIG. 7 is a functional block diagram of a BroadBand Controller (BBC) of FIGS. 2, 3 and 4.

FIG. 8 is a functional block diagram of a Quad Digital Subscriber Line Card (QDC) of FIGS. 2, 3 and 4.

FIG. 9 is a signal diagram showing a source specific multicast signal flow, according to principles of the present invention, between an Edge Aggregation Router, various nodes of a remote digital terminal and an optical networking unit, and a subscriber gateway;

FIG. 10 is a clock-to-signal timing diagram showing a double data rate transmission, according to an embodiment of the present invention, between a BroadBand Controller and a Quad Digital Subscriber Card;

FIG. 11 is a block diagram illustrating internal system interfaces of narrowband communications between a Remote Digital Terminal (RDT) and Optical Networking Unit (ONU);

FIG. 12 is an exemplary superframe of data that may be processed for network communications according to an embodiment of the present invention;

FIG. 13A is a block diagram illustrating the processing of packets from a superframe;

FIG. 13B is a detailed exemplary set of packets of FIG. 13A processed from the superframe of data in FIG. 12, according to an embodiment of the present invention;

FIG. 13C is a block diagram illustrating the formation of a frame of data from packets at a node into a frame of data;

FIG. 14A is a block diagram illustrating the processing of a superframe from packets at a QOIU according to an embodiment of the present invention;

FIG. 14B is a block diagram illustrating the formation of packets from a narrowband signal at a BBC according to an embodiment of the present invention;

FIG. 15A is signal diagram illustrating the detection of a network connection using Virtual Local Area Network (VLAN) identification according to an embodiment of the present invention;

FIG. 15B is a block diagram illustrating a system for detecting a network connection using VLAN identification according to an embodiment of the present invention;

FIG. 16 is a flow diagram illustrating detection of a network connection using VLAN identification according to an embodiment of the present invention;

FIG. 17 is a block diagram illustrating an embodiment of the present invention within the IPTV system;

FIG. 18 is a high level diagram illustrating an embodiment of the present invention for generating a network quality clock signal;

FIG. 19 is a system timing block diagram showing use of a digitally controlled oscillator and a voltage controlled oscillator for generating a network clock signal according to an embodiment of the present invention;

FIG. 20 is a diagram illustrating jitter reduction using a digital Phase Locked Loop; and

FIG. 21 is a diagram illustrating jitter reduction using an analog Phase Locked Loop.

### DETAILED DESCRIPTION OF THE INVENTION

A description of preferred embodiments of the invention follows.

According to an embodiment of the present invention, a system or corresponding method increases available bandwidth for transmission of data, video, and audio to a customer, or sometimes a curb local to a customer, within a network. The system may include multiple network nodes. In one embodiment, first network node in the system converts a first optical communications signal to a corresponding first electrical signal with an asynchronous, packet-based format. The first network node processes the first electrical signal in a corresponding, asynchronous, packet-based manner, and routes the first electrical signal to a second network node among a group of secondary network nodes. This second network node converts the first electrical signal to a second optical signal and routes the second optical signal to a third network node among a group of tertiary network nodes. The third network node converts the second optical signal to a corresponding second electrical signal with an asynchronous, packet-based format, processes the second electrical signal in a corresponding, asynchronous, packet-based manner, and routes the second electrical signal to a fourth network node among a group of quaternary network nodes. This fourth network node may transmit the second electrical signal to at least one end user node.

In one embodiment of the invention, a communications system, such as a Digital Subscriber Line Access Multiplexer (DSLAM), or corresponding method, increases available bandwidth for transmission of data, video, or audio to a customer premise, or curb node, for further distribution to customer premises within a network. In one embodiment, a system comprises a host digital terminal (HDT), including an Ethernet switch unit and multiple optical interface units coupled via at least one communications bus. The optical interface units may be configured to communicate over an optical communications link with broadband cards of optical network units (ONUs). The ONUs also include data cards coupled to the broadband cards via at least one communications bus. The data cards may be configured to communicate over end user communications links to end user nodes.

Some embodiments of the present invention provide network access to higher speed video and data transmissions. An example architecture provides Fiber to the Curb (FTTC) that supports higher bandwidth to the customer premise than a Digital Subscriber Line Access Multiplexer (DSLAM) Host Digital Terminal (HDT) or Central Office solution.

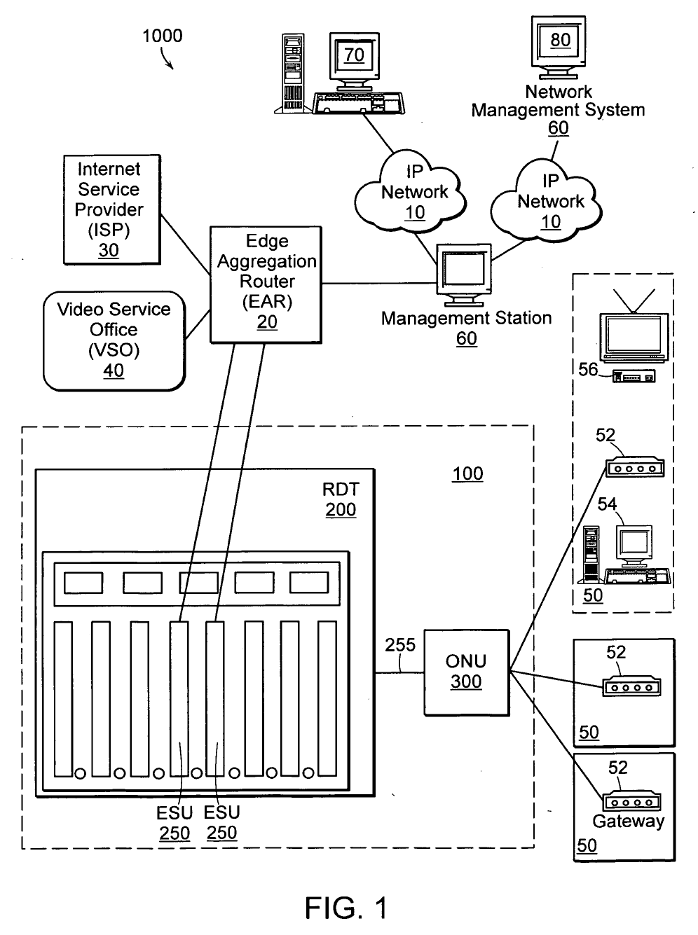

FIG. 1 illustrates an Internet Protocol Television (IPTV) system 100 according to an embodiment of the present invention within a network 1000. The IPTV system 100 may serve as an interface between an end user node, such as a residential gateway 52, and an Edge Aggregation Router (EAR) 20 that may provide voice, video, and/or data services from a media provider.

The EAR 20 may provide access to a Video Service Office (VSO) 40, as well as Internet traffic through an Internet Service Provider (ISP) 30. A management station 60 may operate as an Element Management System (EMS) server to provide low level management and surveillance functions for the system 100. The EMS server 60 may host some or all sessions for a client 70 to access the IPTV system 100. In addition, the EMS server 60 may also communicate with a customer's network management system 80 for service activation, surveillance, and alarm reporting. These communications may be made through a network, such as an Internet Protocol (IP) network 10. The network management system 60 may be an application platform used for managing some or all of the systems in a multi-vendor environment, may provide seamless access to some or all IPTV systems, and may provide some or all flow-through capabilities for service activation and maintenance.

The EMS server 60 may be a custom or commercial server, such as a Sun Solaris® based server application. The EMS client 70 may be an application program and may be loaded onto Microsoft® windows® or a Sun Solaris® workstation. The client 70 may provide a Graphical User Interface (GUI) front end to the element management system application and may communicate to the EMS server 60. The client 70 allows EMS users to make changes to the IPTV system 100, generate reports, and view status data.

The IPTV system 100 may also interface with an end user node, such as a residential gateway 52, on customer premise(s). In one embodiment, the gateway 52 can provide an interface to customer premises devices 54 for access to the Internet, while also providing an interface to a set top box 56 for providing video services. The IPTV system 100 may provide delivery of voice, video, and/or data services from a central location to multiple homes.

In the embodiment of FIG. 1, the IPTV system 100 comprises two main components. The first component is a Remote Digital Terminal (RDT) 200 (referred interchangeably with Host Digital Terminal (HDT)), which provides access points from the router 20. The RDT 200 connects to Optical Networking Unit (ONU) 300 through an optical fiber 255 connection. In a communications system, a single RDT 200 may connect to multiple ONUs through multiple optical fiber connections. The ONU 300 may be located in a local neighborhood to provide the delivery of voice, video, and data services to a number of customer premises 50.

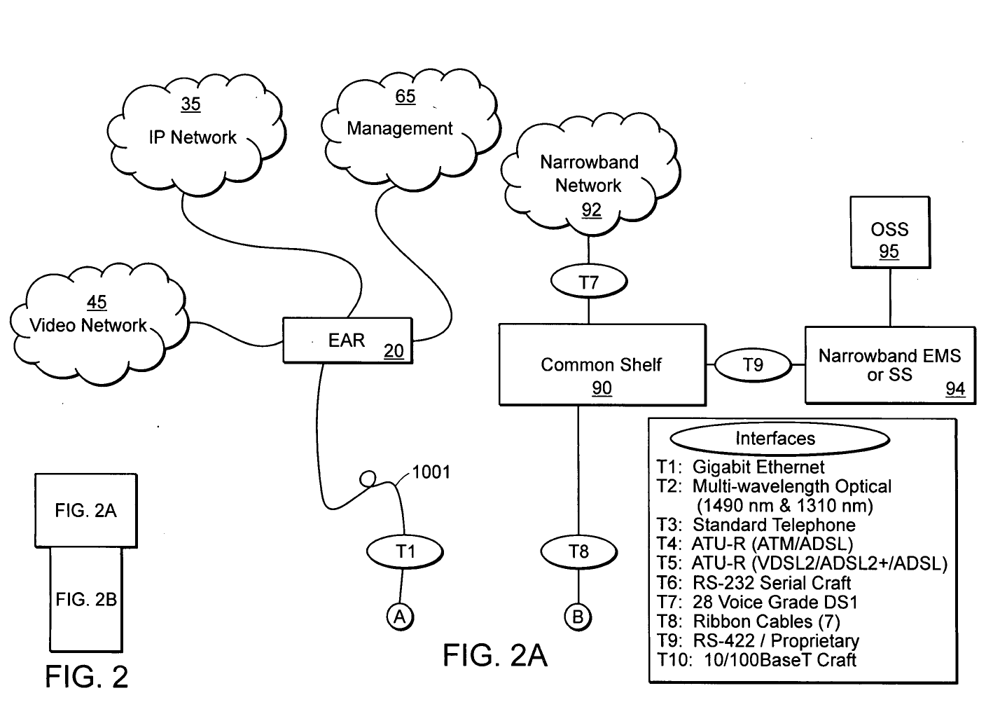

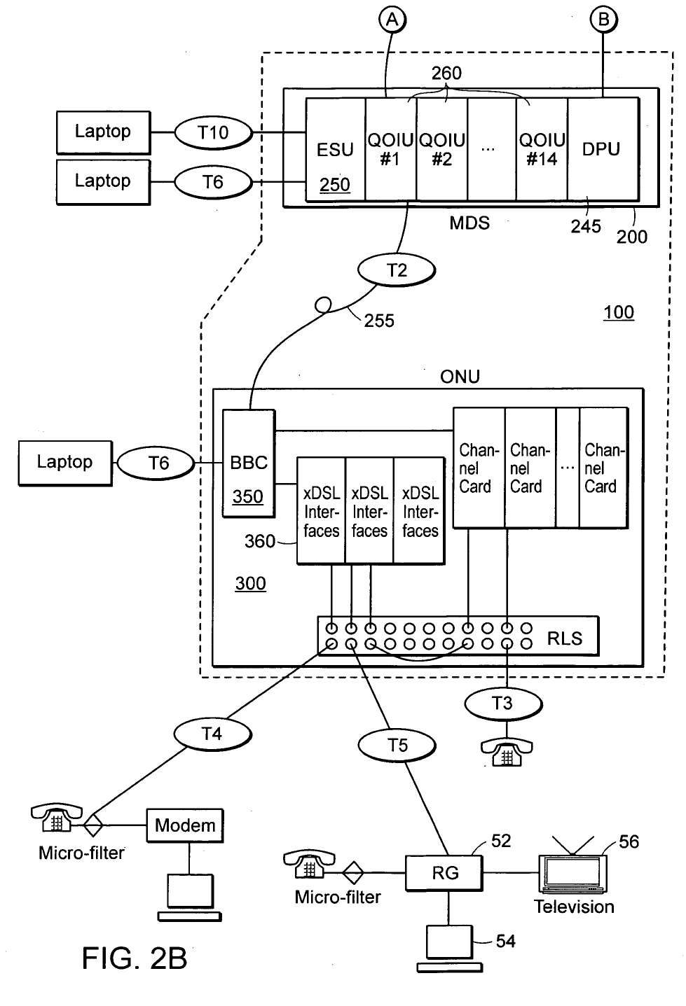

FIG. 2 sets forth a more detailed schematic of the system 1000 shown in FIG. 1. As with FIG. 1, the IPTV system 100 of FIG. 2 has both a Remote Digital Terminal (RDT) 200 and an Optical Network Unit (ONU) 300. Referring to FIG. 2, the RDT 200 may receive incoming signals from the Edge Aggregation Router (EAR) 20 through an optical gigabit Ethernet (GigE) connection 1001 at an Ethernet Switch Unit (ESU) 250 of the RDT 200. The EAR 20 may provide access to a number of Video Service Offices (not shown) through a video network 45, as well as Internet traffic 35. A management station (not shown) may connect to the EAR 20 through a management network 65.

The ESU 250 may be responsible for a first layer of multicast replication within the system 100. The ESU 250 may perform a proxy function for the network elements to track and keep proper multicast channels (not shown) flowing from the EAR 20, through the IPTV System 100, and to the end nodes 52.

The RDT 200 may also have a Distribution Processor Unit (DPU) 265. The DPU 265 may provide the RDT 200 with access to a common shelf 90, such as a DISC*S® common shelf made by Tellabs Operations, Inc., at a Central Office. The common shelf 90 may perform call processing and provide a TR-008 or GR-303 interface to the voice switch. The common shelf 90 may further include a connection to a narrowband network 92 and a narrowband element management system (EMS) 94. The narrowband EMS 94 may provide an interface to the system operator's Operational Support Systems (OSS) 95. The EMS 94 may manage tasks, such as system configuration, provisioning, maintenance, inventory, performance monitoring, and diagnostics.

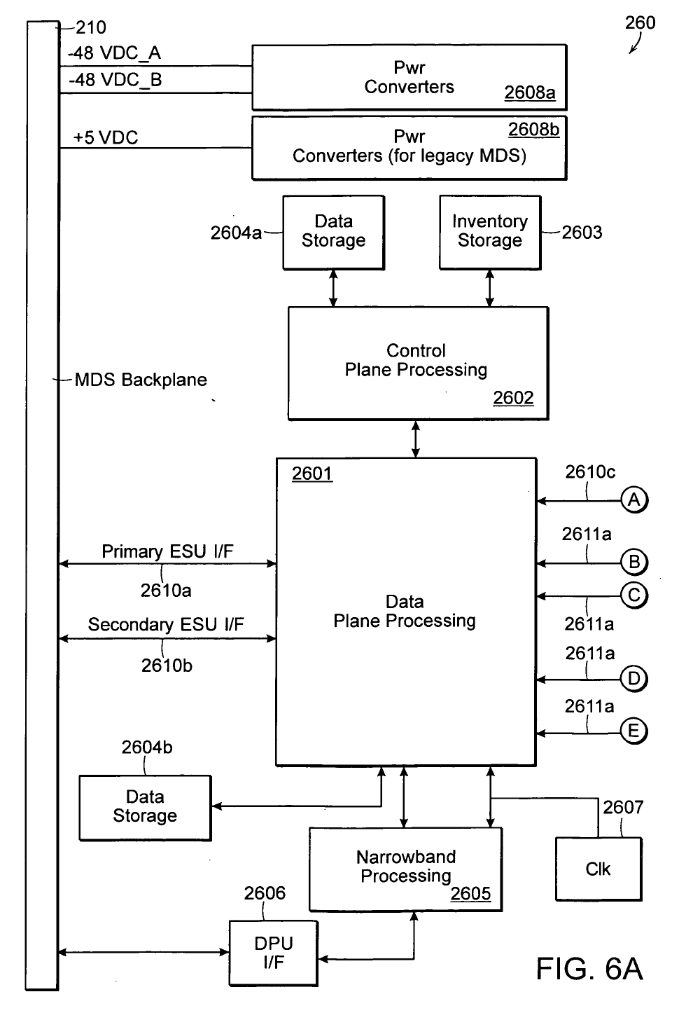

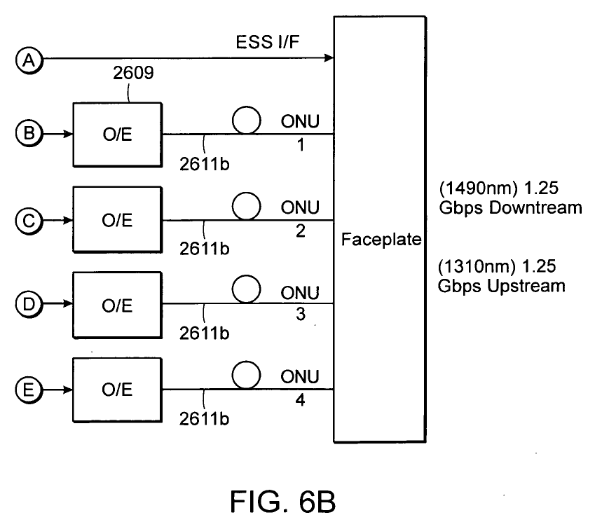

In an embodiment shown in FIG. 2, the ESU 250 connects with fourteen Quad Optical Interface Unit (QOIU) cards 260 within the RDT 200. Within the system 100, an Ethernet switch (discussed in detail below with respect to FIG. 6) located in the QOIU 260 performs layer 2 functions. Each QOIU may interface via an optical connection 255 with one or more Broad Band Controllers (BBC) 350.

In the embodiment of FIG. 2, the BroadBand Controller 350 (BBC) may be responsible for some or all the operations, administration, management, and provisioning functions within the ONU 300. Each BBC 350 may support multiple quad digital subscriber line cards (QDC) 360. The hardware on the BBC 350 is responsible for distributing IP packets or ATM cells to the QDC 360 cards. In addition, the BBC 350 may provide the optical interface (not shown) between the ONU 300 and the QOIU 260. The QDC 360 serves as the interface to the end user node (e.g., residential gateway 52) in a subscriber premises.

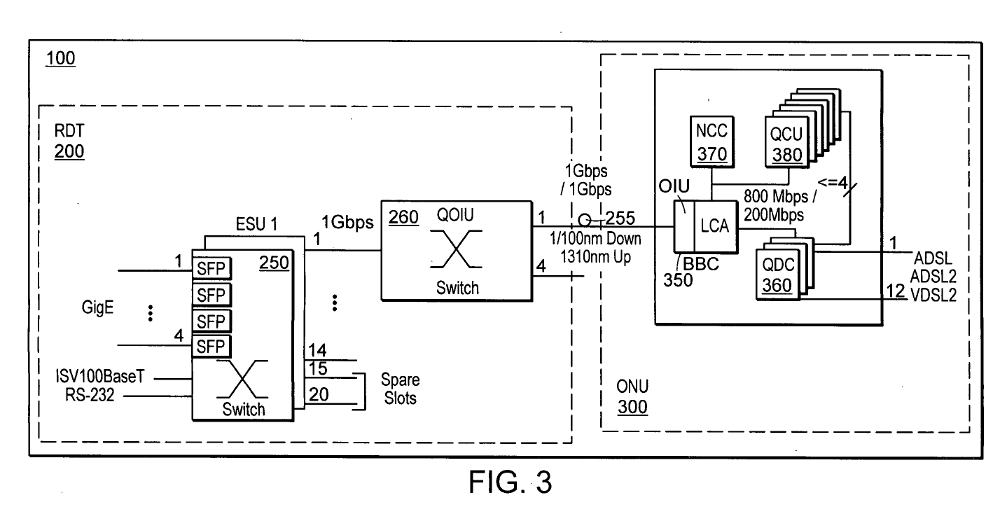

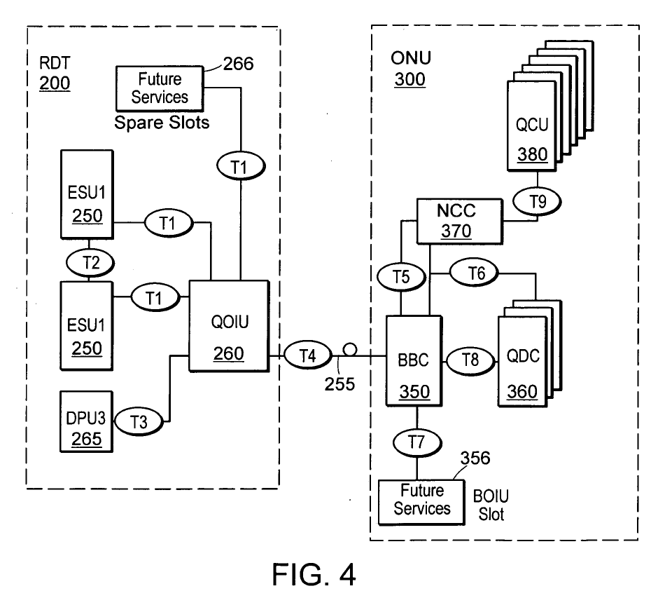

FIGS. 3 and 4 provide a more detailed diagram of embodiments of an IPTV system 100 of both FIGS. 1 and 2.

FIG. 3 illustrates an IPTV system 100 comprising an RDT 200 and an ONU 300. In the embodiment of FIG. 3, within the RDT 200 are at least two primary nodes: at least one Ethernet Switch Unit (ESU) 250 and multiple corresponding Quad Optical Interface Units (QOIU) 260 (only one of which is shown in FIG. 3). The Ethernet Switch Unit (ESU) 250 interfaces with the Quad Optical Interface Units (QOIU) 260 along a backplane (not shown). The ESU 250 may provide an uplink to the EAR 20 of FIGS. 1 and 2, convert optical signals into an electrical signal, and route the electrical signal to an appropriate QOIU 260 using Ethernet Layer 3 information. Each QOIU can subsequently convert electrical signals back into optical signals and transmit the optical signals via optical fiber link(s) 255 to various Optical Network Units 300 (ONU) using Layer 2 information.

In embodiments of the present invention, and as shown in FIG. 4, the RDT 200 may employ two or more ESU 250 units to support a redundancy. As shown in FIG. 4, the ESU 250 connects to the QOIUs 260 in the RDT 200 enclosure. The multiple ESUs 250 may be configured to operate as a single unit, but introduction of redundancy provides additional reliability in the IPTV system 100 shown in FIGS. 1 and 2. Therefore, if one of the ESUs 250 were to fail, the system 100 would lose capacity, but not service. To support this redundancy, the HiGig port from each ESU 250 is cross-connected back to the other ESU 250. Like the QOIU 260 interface, this port may be physically connected to a redundant switch module via the RDT 200 backplane (not shown). Multiple ESUs may be combined to form a load sharing redundant unit via a mechanism known as trunk aggregation. Trunk aggregation allows Ethernet links on different ESUs to combine to form a single logical link. When an ESU fails, as indicated by loss of Ethernet link, the connected devices each may remove that ESU from its aggregation group.

A link layer is a standardized part of the line level Ethernet protocol which determines the presence of a device on the distant end of an Ethernet link. It is a complex protocol which requires that the line interface be fully functional and, as such, provides a significant level of diagnostic insight into the distant end. The devices at the edge of the switching subsystem each make their own determination vis a vis the viability of the switching subsystem, and, therefore, do not require to communicate or coordinate the redundancy failover event with each other. As such, this mechanism is inherently simpler and more reliable than currently offered reliability strategies, both by its inherent simplicity and its ability to absorb multiple failures.

Consistent with the principles of the present invention, systems may be configured to have only one ESU 250 active at any one time, or they may be configured whereby both ESUs 250 are active. Spare slots at the QOIU 260 may also be provided to adapt the RDT 200 for future services 266.

Continuing to refer to FIG. 3, the ONU 300 also has two primary nodes, at least one BroadBand Controller (BBC) 350 and multiple corresponding Quad Digital Subscriber Line Cards (QDCs) 360. Within the ONU 300, the BBC 350 terminates the RDT interface and may split the narrowband traffic to the Quad Channel Units 380 from the broadband traffic to the QDCs 360. The BBC 350 of FIG. 3 also shows a connection with a narrowband common card (NCC) 370. The BBC 350 may receive optical signals from a QOIU 260, convert them into an electrical signal, and switch the electrical signal to the appropriate QDC 260 (for narrowband communications, the NCC 370) using Layer 2 information.

FIG. 4 also illustrates the DPU 265 and QOIU 260 interface which may transport the narrowband traffic between the RDT and common shelf (shown as 90 in FIG. 2). The narrowband traffic may be transported over a superframe format that may include Pulse Code Modulation (PCM), Channel Unit Data Link (CUDL), ISDN 2 B channels (64 kb/s) and D channels (16 kb/s) Pulse Code Modulation and High Level Data Link Control (HDLC) data for up to twenty-four channels in each of four ONUs 300. This interface may also include the DPU 265 BUS (not shown) that may be used by the DPU 265 to control the QOIU 260 narrowband interface.

The QOIU 260 interfaces with a BroadBand Controller (BBC) 350 at the ONU 300 over an optical connection 255. The ONU 300 may have a spare slot at the BBC 350 that may also be provided to adapt the ONU 300 for future services 356.

In one embodiment, the ESU 250 may be responsible for the first layer of multicast replication within the system 100. The ESU 250 may perform an Internet Group Management Protocol (IGMP) proxy function to track and keep all of the proper multicast channels flowing from the Edge Aggregation Router (EAR) 20.

Elements within the RDT 200 and ONU 300, such as the ESU 250, QOIU 260, BBC 350, and QDC 360, may be referred to as “nodes” or “network nodes.” Through use of these nodes, some embodiments of the present invention may be employed. It should be understood that the nodes may be physically separated from each other.

With reference to FIGS. 2, 3, and 4, the optical link 255 between the QOIU 260 and BBC 350 may have a 1.25 Gbps symmetrical interface rate. The interface rate may allow the QOIU 260 switch to be connected to the BBC 350 switch without additional glue logic. The BBC 350 may convert an optical signal (not shown) through a line card aggregator function. Optical circuitry may be provided on a printed circuit board (not shown) in the BBC 350.

The BBC 350 processor may be responsible for some or all of the DSP management functions in the ONU 300. The BBC 350 may support ADSL, ADSL2+, VDSL2, and Quad DS1 line cards.

FIG. 4 shows internal data interfaces between the various components of the IPTV system according to an embodiment of the present invention. A QOIU 260 in the RDT 200 may connect to an ESU 250 gigabit port. In embodiments of the present invention, this interface may comply with the IEEE 802.3 standard. The physical connection between the modules may be via an interface across the RDT 200 backplane (not shown). In embodiments of the present invention, the SerDes signals may connect the Ethernet switch devices on the ESU 250 to the QOIU 260 without the need for external glue logic. The transmission between the two points may employ 8B/10B encoding.

The interface between the QOIU 260 and the BBC 350 provides the link between the RDT 200 and the ONU 300. This interface may be an optical connection 255. In embodiments of the present invention, this optical connection uses a 1490 nm wavelength for downstream transfers and 1310 nm for upstream transfers. In such an embodiment, the raw bit rates for this interface may be 1.25 Gbps downstream and 1.25 Gbps upstream. This connection may support a distance of 12,000 feet between the RDT 200 and ONU 300.

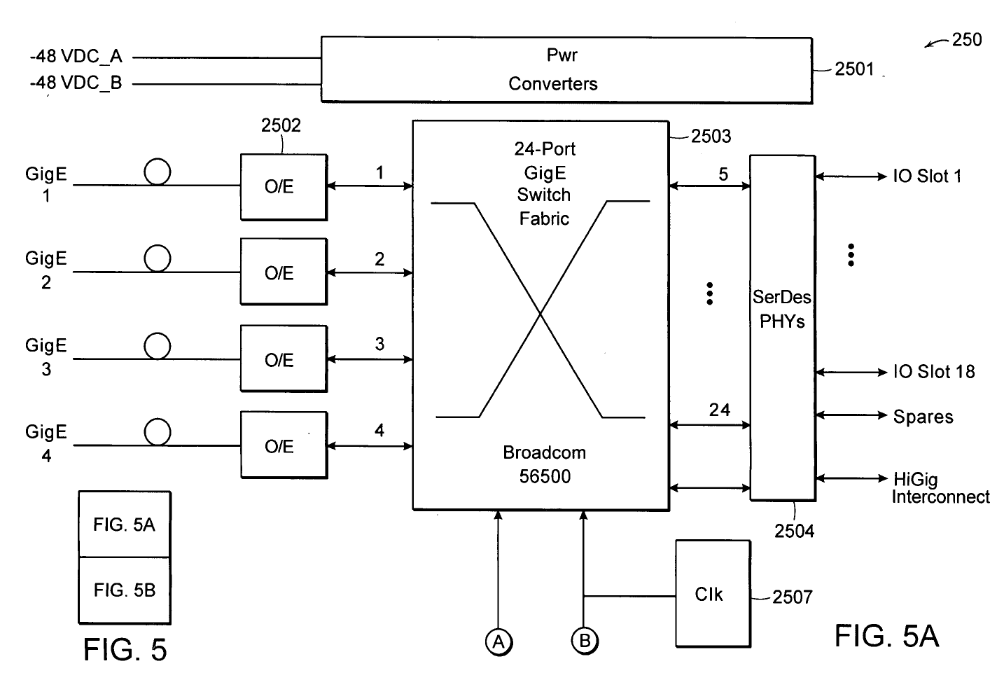

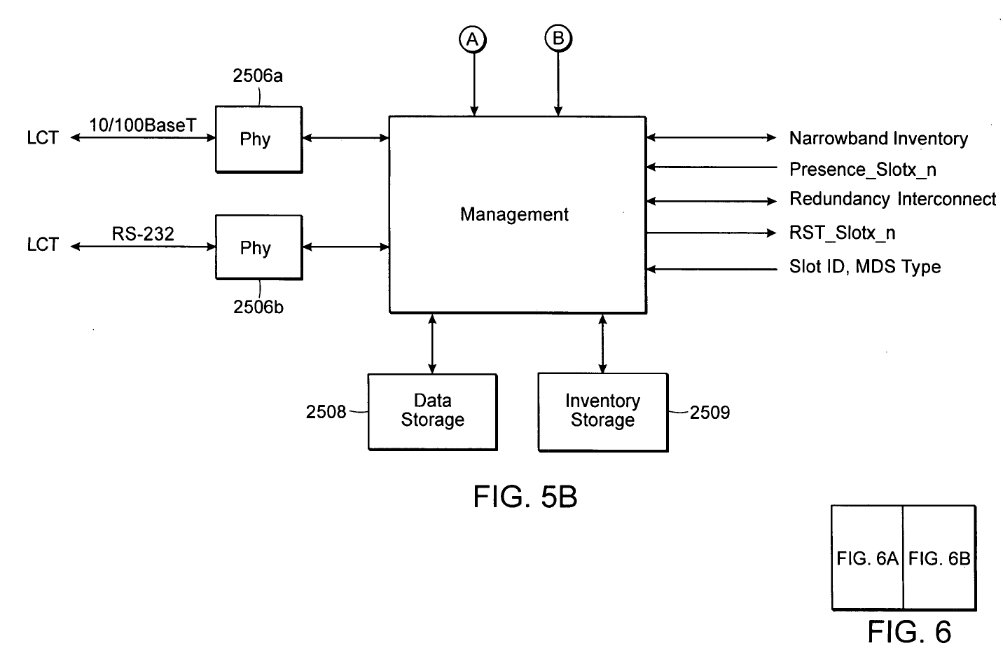

As shown in FIG. 5, in one embodiment of the present invention, the ESU 250 is a 24-Port GigE Layer 2/3 Ethernet switch 2503, such as a Broadcom® BCM56500 24-Port Gigabit Ethernet Multilayer Switch by Broadcom Corporation of Irvine, Calif. In this embodiment, the ESU 250 supports four Small Form-factor Pluggable (SFP) gigabit uplink ports 2502 for optical-to-electrical conversion, and twenty gigabit SerDes interfaces 2504 to its backplane I/O (not shown).

The switch 2503 shown in FIG. 5 connects to a management module 2505 which may support a 10/100BT port 2506a and a serial port 2506b for craft. The management module 2505 may also interface with a data storage unit 2508 and an inventory storage unit 2509. A clock 2507 provides timing for both the switch 2503 and the management module 2505. The ESU 250 of FIG. 5 also has a power converter 2501 that interfaces with the backplane (not shown). The ESU 250 may operate primarily as a Layer 2 Ethernet switch for unicast traffic, but may also have significant Layer 3 capabilities in hardware for multicast traffic.

The RDT 200 may also house one or more Quad Optical Interface Units (QOIU) 260. Each QOIU 260 may connect with an ESU 250 through GigE SerDes links to a backplane (not shown) or through Small Form-factor Pluggable (SFP) ports. The QOIU 260 is specifically designed to support the IPTV architecture with the hardware capability to maintain narrowband (i.e., voice channels) interfaces (shown below with respect to FIG. 6) in existing systems.

In an embodiment of the present invention, as shown in FIG. 6, the QOIU may be equipped with a 12-port Layer 2/3 Ethernet switch 2601, such as either a Broadcom® BCM5695 or the BCM5696 12-Port Gigabit Ethernet Multilayer Switch. In FIG. 6, the Ethernet switch 2601 performs layer 2 functions. Signals 2610a and 2610b may be exchanged between the switch 2601 and both a primary and secondary ESU over a backplane 210. The switch 2601 may also have an interface with a control plane processing module 2602, which in turn interfaces with a data storage unit 2604a and an inventory storage unit 2603. The switch 2601 may also directly interface with a data storage unit 2604b. The switch 2601 may interface with a narrowband processing module 2605, which connects to the backplane 210 through a distribution processing unit 2606.

A clock 2607 may provide timing for both the switch 2601 and the narrowband processing module 2605. In this embodiment, electrical signals 2611a transmit directly with the switch 2601 and four Small Form-factor Pluggable (SFP) gigabit uplink ports 2609 for optical-to-electrical conversion, providing optical connections 2611b with downstream ONUs (not shown in FIG. 6). The switch 2601 may have a port for an Ethernet Aggregation Switch (EAS) interface that provides an additional link for signals 2610c in an upgrade configuration. The QOIU 260 of FIG. 6 also has two power converters 2608a and 2608b that interface with the backplane 210.

Each QOIU 260 may also serve as an interface to a BroadBand controller (BBC) 350 at one or more ONU devices 300 over a multi-wavelength optical connection. In the embodiment shown in FIG. 6, each optical interface of the QOIU 260 provides a bidirectional, symmetrical, 1.25 Gbps link using a 1490 nm wavelength in the downstream path and a 1310 nm wavelength in the upstream path.

In addition to broadband data traffic, this interface between the QOIU and the BBC may transport narrowband payload and maintenance information encapsulated in IP Packets. This interface is symmetrical in that the same types of packets are transmitted in both the downstream path as well as the upstream path. In the downstream path, the narrowband payload is received by the QOIU 260 from the DPU 2606 as in FIG. 6. The QOIU collects the narrowband traffic and forms the payload in a narrowband processing module 2605, and the payload is encapsulated in an Ethernet packet. In the upstream direction, the QOIU switches all narrowband packets to the narrowband processing function 2605. The payload is extracted and sent to the DPU 2606.

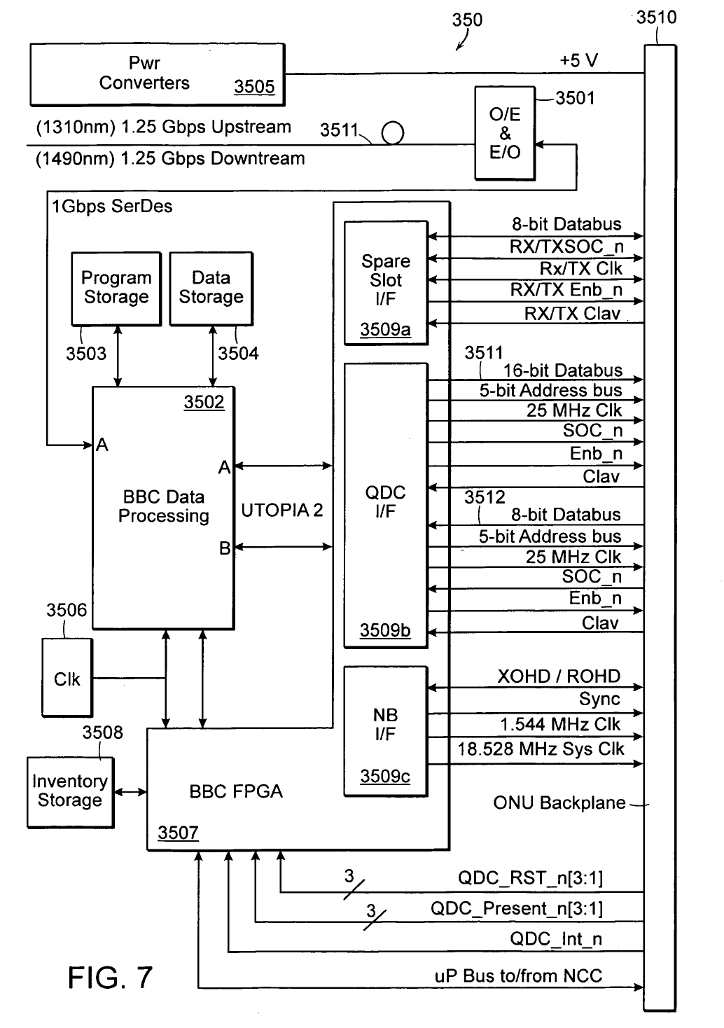

FIG. 7 is an embodiment of a BBC in accordance with an embodiment of the present invention. With reference to FIG. 7, the BBC 350 includes a Line Card Aggregator (LCA) 3502, such as the Broadcom® BCM6550A. An optical-to-electrical converter 3501 interfaces with the DSP 3502 to provide an optical connection 3511 with an upstream QOIUs (not shown in FIG. 6.). The LCA 3502 may also have a program storage module 3503 and a data storage module 3504. The BBC 350 may also have a power converter 3505 that interfaces with the backplane 3510.

The BBC 350 may use a Field Programmable Gate Array (FPGA) 3507 that interfaces with the LCA 3502 and a backplane 3510. In such an embodiment, the FPGA implements some of the functions on the BBC that cannot be handled by the LCA Digital Signal Processor (DSP), such as: Medium Access Control (MAC) address translation between provisioned network MACs and learned subscriber MACs; Virtual Local Area Network Identification (VLAN ID) translation as cell or Packet Transfer Mode (PTM) traffic passes through the device; UTOPIA 2 conversion to/from the ONU backplane UTOPIA architecture; and termination of the narrowband traffic and conversion from the fiber format to that required by the NCC backplane interface and narrowband line cards. A narrowband interface module 3509c is shown on the FPGA 3507. The FPGA 3507 also has a QDC interface module 3509b and a spare interface 3509a. A clock 3506 provides timing for both the DSP 3502 and the FPGA 3507. The FPGA 3507 also interfaces with an inventory storage module 3508.

As shown in FIG. 7, signals from the FPGA 3507 may be exchanged with the QDC (not shown in FIG. 7) over an asymmetrical UTOPIA-like backplane interface 3510. UTOPIA describes a Universal Test & Operations Physical Interface for ATM level 1 data path interface, as defined in technical specifications by the ATM Forum. UTOPIA describes the interface between the Physical Layer and upper layer modules, such as the ATM Layer, and various management entities. The UTOPIA bus is a standard interface between asynchronous transfer mode (ATM) link and physical layer devices. It covers rates from sub-100 Mbit/s to 155 Mbit/s and gives guidance for 622 Mbit/s. 8-bit wide data paths use octet-level/cell-level handshake at 25 MHz. UTOPIA Level 2 is an addendum to Level 1 and describes support of a data rate of 622 Mbit/s over a 16-bit wide data path at 33 and 50 MHz.

The interface to the QDC 360 may be a point-to-multipoint interface. In an embodiment according the principles of the present invention, the downstream transfers may be accomplished on a double-data rate 16-bit bus 3511 while the upstream is an 8-bit UTOPIA bus 3512. The transfer clock rate for both the downstream and upstream data transfers may be 25 MHz.

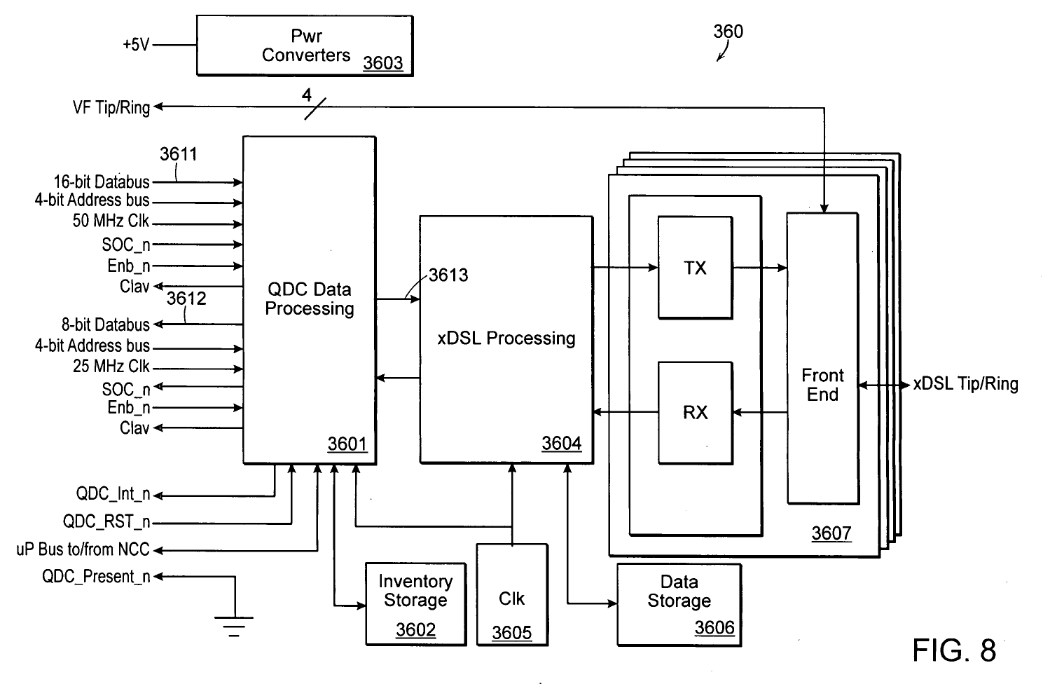

The Quad Digital Subscriber Line Card (QDC) 360 is a subscriber line card in the ONU. This card may support four ports of ADSL/ADSL2+ or VDSL2 service. As shown in FIG. 8, a QDC 360 may consist of a FPGA 3601 that provides the glue logic functions needed to support the interface between the BBC 350 switch and a QDC 360 DSP 3604. A DSP used in a QDC in accordance with the present invention may be the Broadcom® BCM6510. The FPGA 3601 may handle the ATM operations, administration and management functions, as well as the downstream bus 3611 translation from 16 bits double data rate to the DSP's 8-bit single data rate bus 3613. A QDC 360 may be capable of supporting the various XDSL modes of service (e.g. ADSL, ADSL2, ADSL2+, VDSL2 and T1.413). In an embodiment according to the principles of the invention shown in FIG. 8, the card may support four ports of ADSL/ADSL2+ or VDSL service. In embodiments of the present invention, the FPGA may also interface with an inventory storage module 3602. A clock 3605 provides timing between the FPGA 3601 and the DSP 3604. The DSP 3604 may also interface with a data storage module 3606.

In addition to the DSP 3604, the QDC 360 may also comprise analog front ends (AFEs) 3607, line drivers (not shown) and low-pass filters (not shown) for DSL service. As an example, an AFE used in a QDC in accordance with the present invention may be the Broadcom® BCM6505. Management of the QDC 360 may be performed in-band by the BBC 350.

In one embodiment, due to the limitations of existing hardware in ONU backplanes, the interface between the BBC 350 and a QDC 360 is a 16-bit UTOPIA 2 downstream bus 3611 operating at approximately 25 MHZ for all control timing and double data rate for all data bus timing. The QDC 360 may also have a power converter 3603 that interfaces with the backplane (not shown).

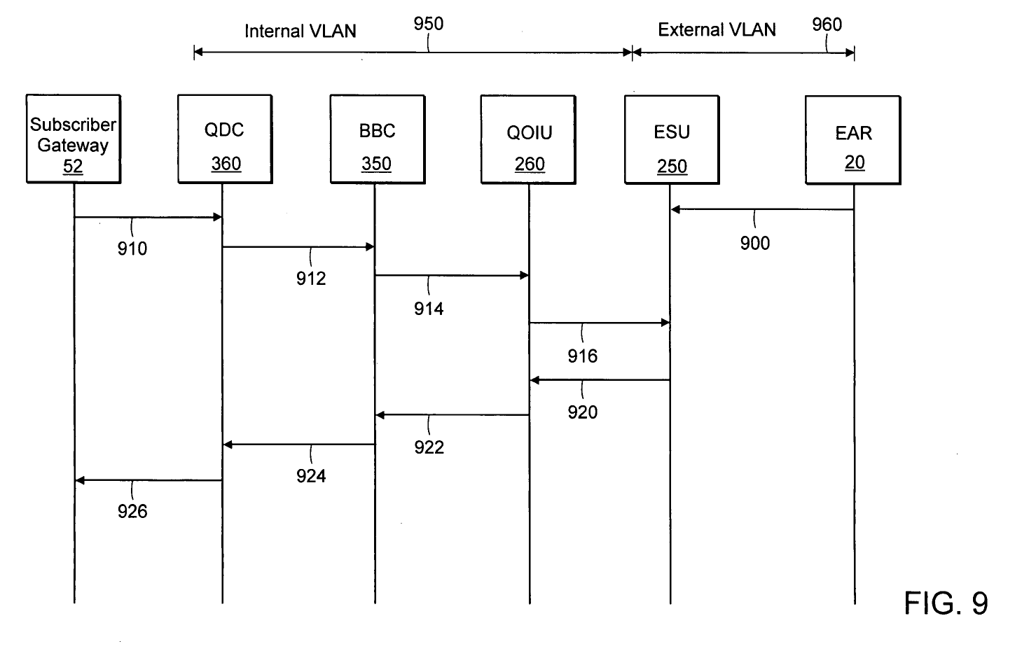

The IPTV system 100 of an embodiment of the present invention as described above allows a service provider to provide a source specific multicast of a signal. According to principles of the present invention, a source specific multicast may be performed in a network, by inspecting a signal for a source specific multicast channel identifier. The source specific multicast identifier signal can be then mapped to a frame switching identifier. The frame switching identifier can be mapped to the signal, allowing the signal to be directed a location based on the frame switching identifier. FIG. 9 is a high level diagram that shows the signal flow for an exemplary source specific multicast according to an embodiment of the present invention.

A subscriber gateway device 52 makes a request to “Join” a particular multicast channel. This “Join” request 910 includes the Media Access Control (MAC) address of the specific device 52, as well as the request for the specific channel. This request 910 travels upstream through the IPTV system. The signal first arrives at the QDC 360, where the signal 912 is forwarded to the BBC 350. From the BBC 350, the signal 914 is forwarded to the QOIU 260. At the QOIU, the signal 916 is forwarded to the ESU 250.

At the ESU 250, an Edge Aggregator Router (EAR) 20 may feed a source specific multicast signal 900 to the ESU 250. The ESU 250 inspects the signal 916 for a source specific multicast channel identifier. The ESU 250 then maps the multicast signal 900 to a frame switching identifier, such as an Ethernet frame, and then applies the frame switching identifier to the signal 916. Once the signal is mapped, the multicast signal 900 may be switched back to the subscriber gateway 52 through the various port assignments through a switching stream 920, 922, 924, and 926. At the subscriber gateway 52, the frame switching identifier of the received signal 926 may be translated to a different identifier for processing. This different identifier may include the original source specific multicast channel identifier, including an Internet Protocol (IP) address, or some unique predefined channel identifier. The source specific multicast channel identifier may be mapped using a destination address, or a destination address and some combination of a source address or VLAN address.

The signal flow allows for the inspection of a multicast signal 900 with Ethernet Layer 3 information to be mapped to Layer 2 frames for delivery through a switching stream 920, 922, 924, and 926. In some instances, intermediary nodes, such as the QDC 360, the BBC 350, or the QOIU, may already be aware of a particular VLAN assignment made to the requested channel 910, and may assign the switching port, accordingly.

In an embodiment of the present invention, the system provides a Layer 2 MAC bridge between the network 100 and the subscriber 52, with a VLAN 950 separation of traffic (e.g., different Virtual Local Area Networks (VLANs) may be used for different Internet Service Providers (ISPs)). In one embodiment, there is no bridging provided between subscribers. This may be referred to as “forced forwarding” from the subscriber to the network. Further, the system may provide replication of multicast streams from the network to subscribers based on subscriber Internet Group Management Protocol (IGMP) requests. At any point in the system, multicast signals can be replicated and directed to a number of different nodes within a different downstream switching stream (alternative switching streams not shown).

Data traffic on the network side may fall within various VLANs. These VLANs may include:
Management VLAN—may contain management traffic from an element management system.
IPTV VLAN—may contain the IPTV source specific multicast streams
IPTV Internet VLAN—may contain traffic to the internet for IPTV subscribers in a separate VLAN from the multicast video traffic.
Legacy VLAN—may carry traffic from legacy subscribers with ADSL Internet and no IPTV.
Other ISP VLANs—may carry traffic from other third-party ISPs
Point to Point VLAN—may provide a Point-to-Point service as a VLAN per port.

In accordance with certain embodiments of the present invention, the subscriber interface to the IPTV system may be an ADSL, ADSL2+ or VDSL interface. For example, the primary protocol stack may be (i) Ethernet over ATM Adaptation Layer 5 (AAL5) for Asymmetric Digital Subscriber Line (ADSL) and (ii) Ethernet over EFM for VDSL. Specific layers above the primary protocol stack may depend on the type of subscriber and network device(s) to which the subscriber is connected. In an Ethernet system, traffic may be bridged before it can reach a Broadband Remote Access Server function.

A simple VLAN implementation may involve a Transparent LAN service (TLS). The implementation is a standard Ethernet switch in which a network VLAN is added at the subscriber port. If the subscriber port contains a VLAN, the network VLAN is stacked on top of the subscriber VLAN. Within the access network (e.g., Matrix (MX) or Fiber-in-the-Loop (FITL)), the BBC's DSP (shown in FIG. 7) in the ONU may be configured as a network VLAN endpoint. Ethernet traffic may be passed with no filtering. Virtual MACs may not be allowed in this configuration. If the subscriber connection is ATM, there may be multiple Permanent Virtual Circuits (PVCs) on the connection, and each PVC may be mapped to a separate network VLAN. Some embodiments do not allow for multiple PVCs to be mapped to the same VLAN. Internal routing to the PVC may be based on the VLAN ID only. This VLAN configuration is sometimes referred to as 1:1 or port-based VLANs.

In embodiments of the present invention, legacy ATM Internet subscribers may use a similar implementation as Transparent LAN services (TLS) with some exceptions. With legacy ATM, only one PVC is used. Further, in such embodiments, all network traffic may be Point to Point Protocol over Ethernet (PPPoE). This means it may be possible to apply a filter to allow only PPPoE traffic. This VLAN configuration is N:1, meaning that multiple subscribers map to the same network VLAN, and routing to a port is based on VLAN and MAC. Finally, with a Legacy ATM service, it may be possible to configure Virtual MACs (i.e., up to eight), if desired.

In connection with an embodiment of the present invention, IPTV subscribers can have two paths to the network. One path is for Internet (ISP) traffic, and the second path for the video network. In this configuration, the IPTV system may perform some additional routing beyond a standard Ethernet switch. In particular, the IPTV system may separate the Video and ISP traffic into two separate network VLANs. Network to subscriber routing may be standard. Both VLANs may be merged to a single port. In one embodiment, multicast traffic and Internet Group Multicast Protocol (IGMP) queries may be routed from the video VLAN to the subscriber. There may be no unicast traffic on the video network in some networks. The subscriber-to-network routing may be more complicated. The following operation occurs at the subscriber edge. Depending on the service, the IPTV system according to some embodiments of the present invention either (i) translates VLAN identifiers or (ii) inserts on subscriber ingress and removes on subscriber egress. When inserting a tag, the priority may also be specified. The translation values or insertion values may be provisioned on a per circuit (port or ATM VC) basis.

In embodiments according to the present invention, MAC address translation may be provided on the subscriber ports. The addresses to use for translation may be assigned as a block to the IPTV system. The simplest implementation is to assign a block equal to the number of ports times eight and to use a fixed mapping per port. MAC address translation provides certain the benefits, such as prevention of certain attacks (e.g., MAC routing table spoiling, impersonation, etc.). Protection may also be provided from duplicate MAC addresses with different customers (e.g., due to manufacturer errors or user misconfiguration). Other embodiments may be used for IP address assignment and additional security in the network (e.g., MAC address identifies the port).

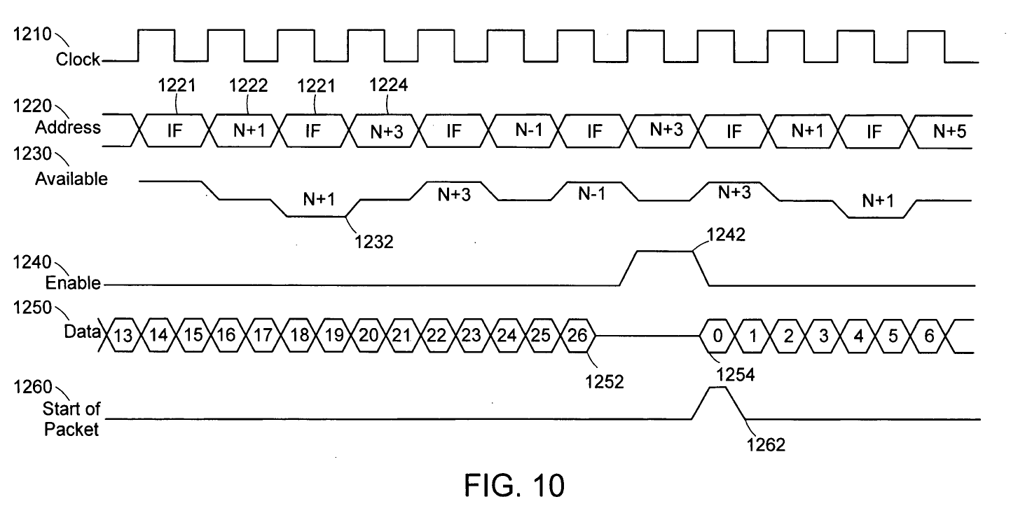

Although the BBC/QDC interface is a UTOPIA level 2-like interface, the clock-to-data and control signal timing relationship may be modified to increase performance of the interface. In particular, data may be transmitted at a “double data rate” between the BBC 350 and QDCs 360 at the ONU 300 in order to improve system bandwidth. According to embodiments of the present invention, data is transmitted between a first node, e.g. a BBC 350, and at least one second node, e.g. a QDC 360 of an optical networking unit. Data transmission begins at the first node, which polls at least one second node for availability of a data transfer. The polling occurs at a first rate, typically based on a rise and a fall of a clock cycle generated from the first node. Once the first node receives a signal indicating a second node's availability to receive data, the first node sends an initiating signal to the second node and begins transferring data to the at least one available address at twice the first rate used for the polling. An overall interface signal timing is specified in FIG. 10.

FIG. 10 shows a signal timing between a BBC 350 (not shown in FIG. 10) and a QDC 360 (not shown in FIG. 10). A clock signal 1210 provides synchronization between the BBC 350 and the QDC 360, and a given rate may be based on the rising and falling edges of the clock cycle for which a data transfer may be associated. In one embodiment, the BBC 350 continually transmits a polling signal 1220 at every other clock cycle to the QDCs 360 for availability of a data transfer, sending a source address 1222, 1224. In-between polling transmissions, the BBC 350 may transmit an idle signal 1221. The BBC 350 may have any number of signal source addresses to send in a polling signal. The BBC 350 may select to transmit any one of those source addresses based on various types of networking algorithms. For example, the BBC 350 may select the signal source address sequentially, using a priority queue method, or a round robin method.

In one embodiment, a QDC 360 communicates with the BBC by providing a signal that indicates availability 1230. When the QDC is available to receive a data transmission from an available address, the transmission signal 1230 indicates availability to receive a particular address 1232. As shown in FIG. 10, the BBC 350 continues to send polling requests 1220 while it is transmitting data 1250. Once the BBC 350 completes a transmission 1252, having previously received an availability signal 1232 from a QDC 360, the BBC sends a transmission initiation signal 1242 to the particular QDC 360. Subsequently, the BBC may simultaneously send a “start of cell” (or alternatively “start of packet”) signal 1260 and begin transferring data 1254 to the at least one available address at twice the first rate. By receiving the initiation signal 1242, the QDC 360 knows that the subsequent data transmission from the BBC 350 occurs at a double data rate.

As mentioned briefly above in referenced to FIG. 6, the IPTV system of an embodiment of the present invention allows communication of narrowband traffic between a remote digital terminal (RDT) and a number of Optical Network Units (ONUs).

According to embodiments of the present invention, a system or corresponding method provides narrowband communications across a communications link through processing a superframe of data into packets. In one embodiment, a first node, such as a Quadrature (Quad) Optical Interface Unit (QOIU) in an RDT, repackages a superframe of data, containing multiple subframes of data in known positions within the superframe, into multiple packets where the payload area may include narrowband data (e.g., voice data). A sequence indicator may be inserted into a payload area of the multiple packets. The sequence indicator may correspond to a subframe in the given communications packet and its position within the superframe.

The packets may be transmitted across a connection to a second node, such as a BroadBand Controller (BBC) of an ONU. The transmission may occur at a rate of 500 μsecs, for example, optionally as part of broadband data packets transmitted at higher rates where the multiple subframe packets are carried on an as-available basis, causing a jitter in a received rate. At the second node, sequence indicators in the payload portion of each of the packets may be inspected. The multiple subframes of data may be extracted along with corresponding command and control information. Using the sequence indicators, frames of data may be formed from the multiple subframes of data.

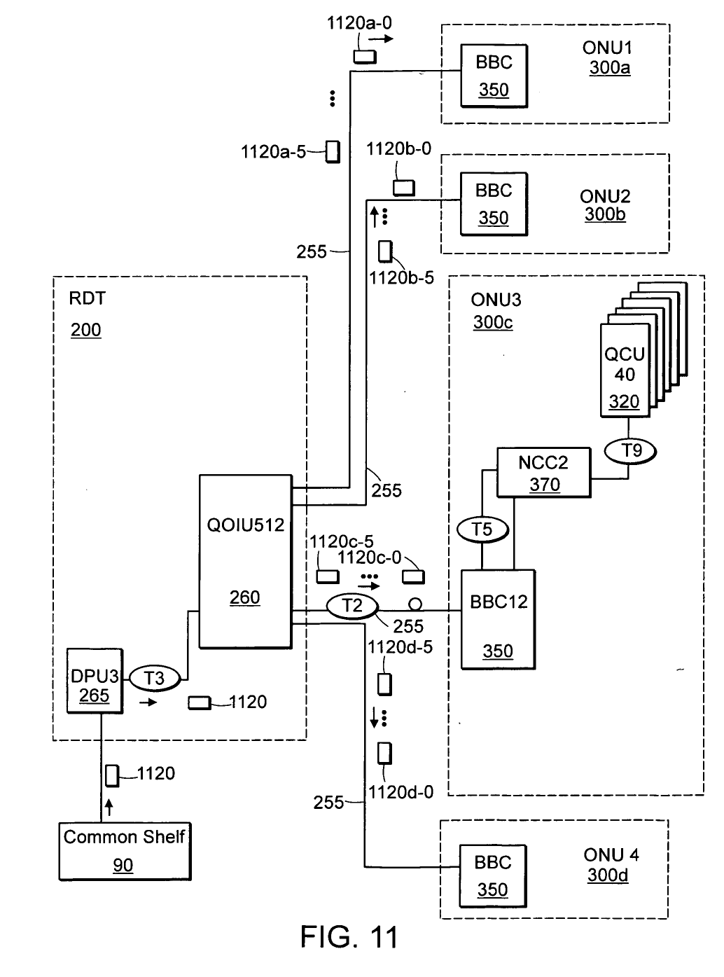

FIG. 11 illustrates an embodiment of the narrowband communications system interfaces between an RDT 200 and four ONUs 300a-d. In this embodiment of the present invention, a common shelf 90, such as a DISC*S® common shelf made by Tellabs Operations, Inc., at a Central Office (not shown) may perform call processing and provide an interface such as a TR-008 or GR-303 interface, to communication narrowband traffic. The narrowband traffic may be configured in a superframe format and transported using Time Division Multiplexing (TDM), which may include timeslots of data encoded using, for example, Pulse Code Modulation (PCM), Differential Pulse Code Modulation (DPCM) Channel Unit Data Link (CUDL), or ISDN 2 B channels (64 kb/s) and D channels (16 kb/s) Pulse Code Modulation. The superframe format may include High Level Data Link Control (HDLC) data for up to twenty-four channels in each of four ONUs 300.

The common shelf 90 of FIG. 11 sends a superframe 1110 to a data processing unit (DPU) 265. The DPU 265 sends the superframe 1110 to a Quadrature (Quad) Optical Interface Unit (QOIU) 260, which processes the superframe 1110 into multiple packets 1120a, 1120b, 1120c, 1120d to send to respective ONUs 300a-d.

In the embodiment of FIG. 11, the QOIU 260 interfaces with BroadBand Controllers (BBC) 350 at four individual ONUs 300a-d over optical connections 255. After processing the superframe 1110 into individual packets 1120a-d, the QOIU sends the packets to the particular ONU based on identifiers in the packets. As shown in FIG. 11, the QOIU 260 sends packets 1120c-0 through 1120c-5 (1120c-0 . . . 5) to a BBC 350 at ONU3 300c. Because the narrowband packets share the same optical connections 255 with broadband communications, these narrowband packets 1120c-0 . . . 5 are interleaved at a particular frequency with broadband communications occurring between the QOIU 260 and the BBC 350. As illustrated, the QOIU 260 also sends narrowband packets 1120a-0 . . . 5, 1120b-0 . . . 5, and 1120d-0 . . . 5 to other ONUs 300a, 300b, and 300d, respectively.

In an embodiment of the present invention, the narrowband packets 1120a-d are sent from the QOIU 260 to the corresponding BBC 350 every 500 μsecs. The BBC 350 may process the packets and send the narrowband communications to a narrowband common card (NCC) 370, and subsequently to appropriate one(s) of the Quad Channel Units (QCUs) 380.

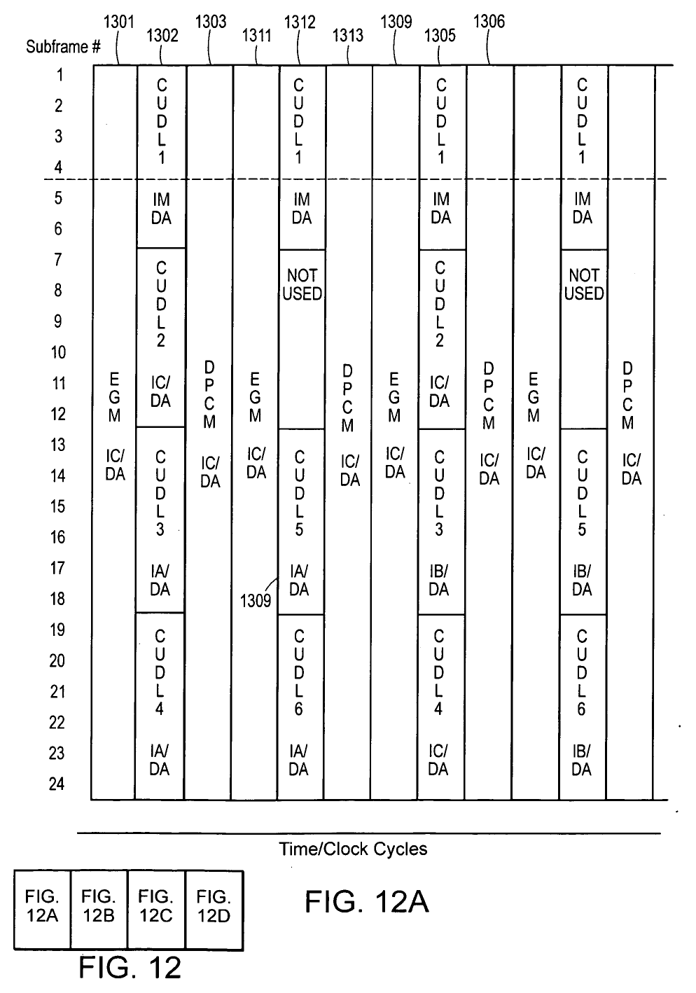

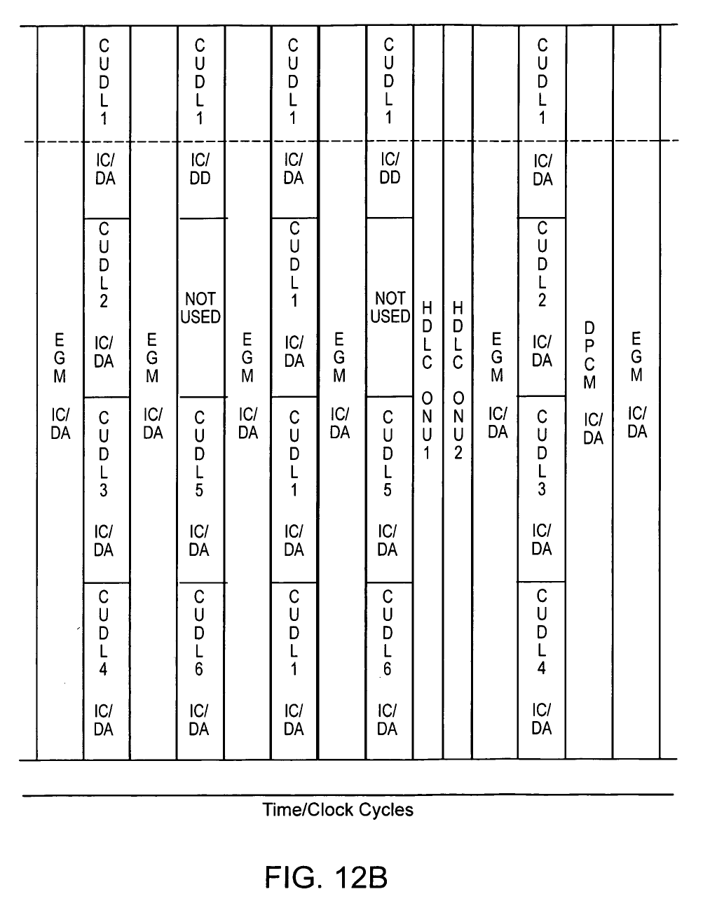

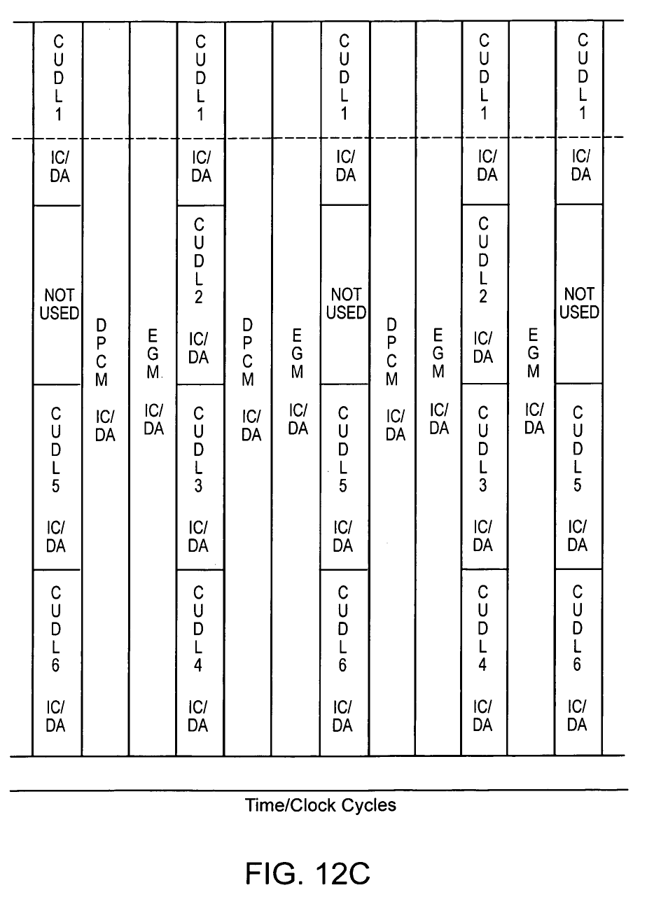

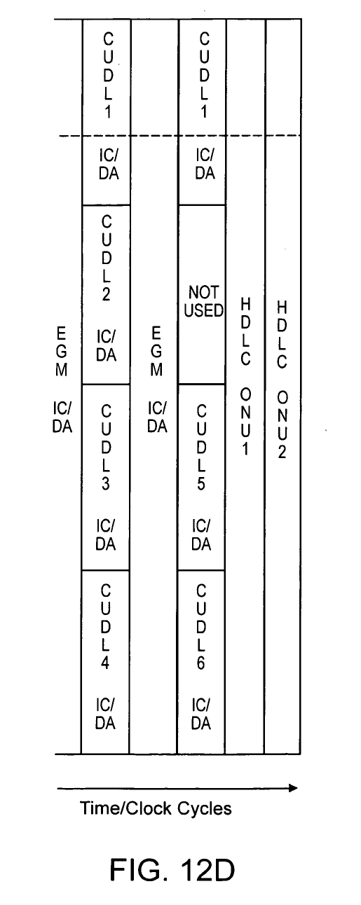

FIG. 12 is an exemplary superframe 1110 according to an embodiment of the present invention. In the embodiment of FIG. 12, the superframe 1110 may be organized in twenty-four subframes, indicated as rows 1-24. Across each row (i.e., subframe), the superframe 1110 contains data organized for four superframe groups, designated DA, DB, DC and DD. These designates may provide a unique source address that identifies a unique communications path of the sequence of packets. In a 24-Channel mode, the superframe groups are associated with one of the four ONUs 300a-d connected to the QOIU 260 (i.e., group DA corresponds to ONU1 300a, group DB corresponds to ONU2 300b, and so forth). Within each group there are four timeslots, designated as TA, TB, TC, and TD. As indicated within the superframe format, PCM, DPCM, CUDL, and HDLC data provide twenty-four channels to the four ONUs (300a-d in FIG. 11). For example, viewing the superframe 1100 from left to right, the first few bytes of data for all twenty-four subframes are allocated to PCM TA/DA, which is the Pulse Code Modulation data for timeslot TA for group DA (e.g., ONU1 300a).

The superframe 1110 of FIG. 12 is split in half, such that groups DA and DB's format is mirrored for groups DC and DD, where each half supports two ONUs. The particular superframe 1110 shown in FIG. 12 is organized to allocate CUDL bytes to six subframes. Further,6 groups DA and DC are each allocated six CUDL groups per timeslot (e.g., CUDL1 TA/DA, CUDL2 TA/DA, . . . etc.), whereas groups DB and DD are each allocated only one CUDL group per timeslot. One of ordinary skill in the art will understand that a superframe may be organized in other ways consistent with embodiments of the present invention. For example, in 12-Channel mode (not shown in the figures), an odd numbered ONU may share its group with an even numbered ONU. Accordingly, group DA is shared across ONU 1 300a and ONU 2 300b while group DC is shared across ONUs 3 and 4, 300c and 300d, respectively.

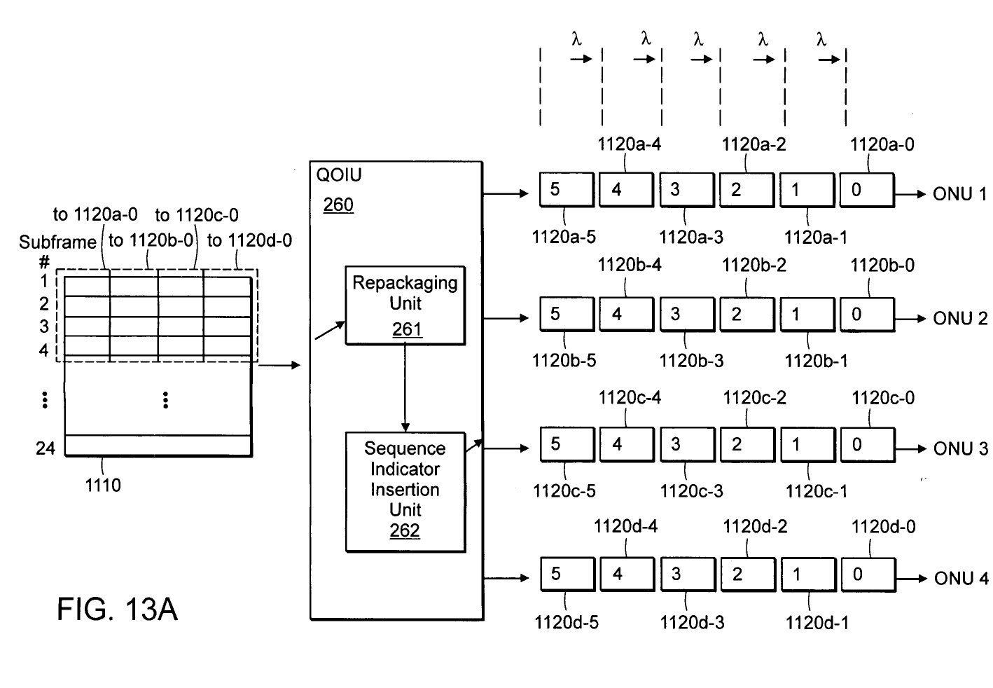

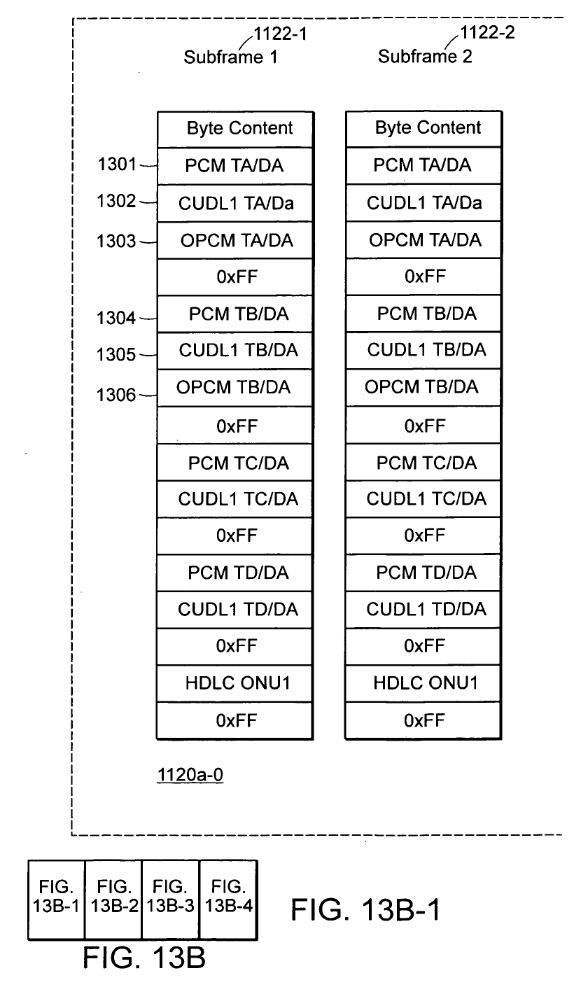

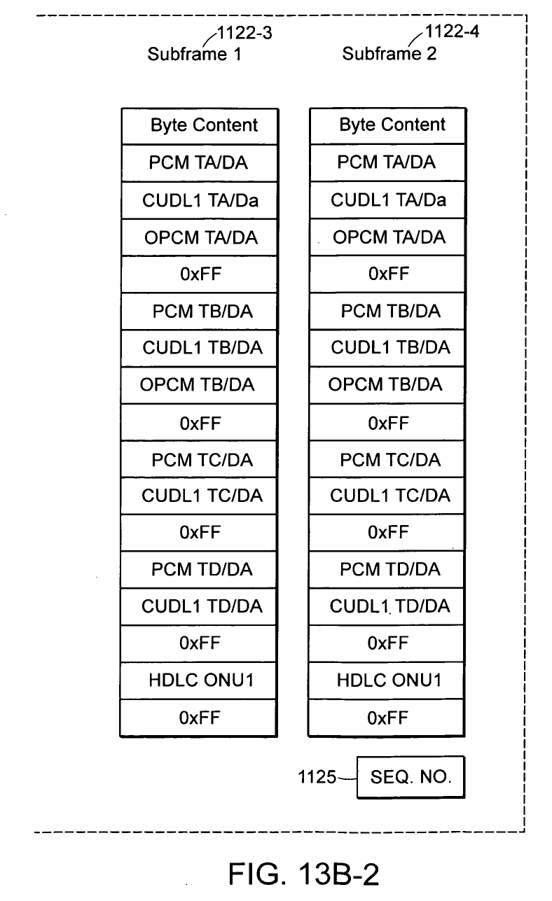

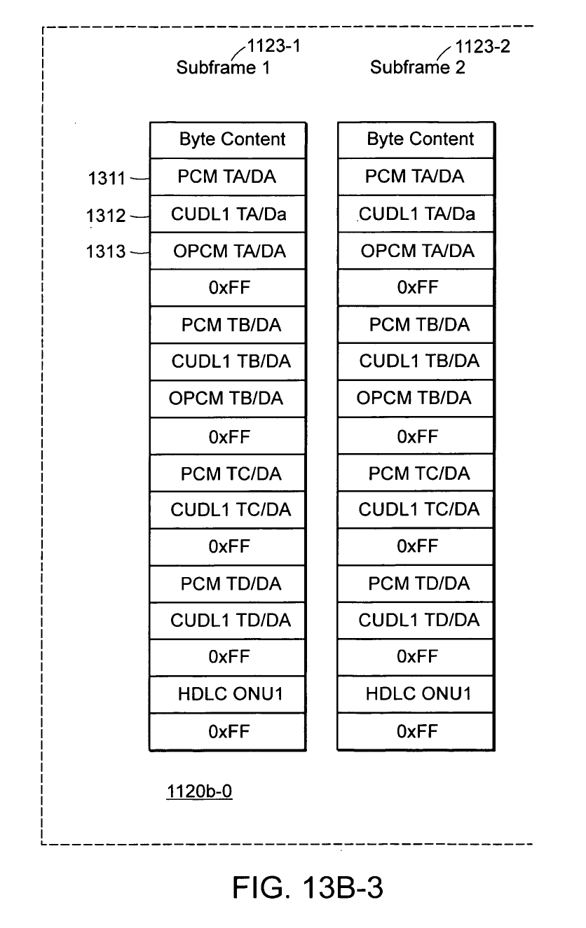

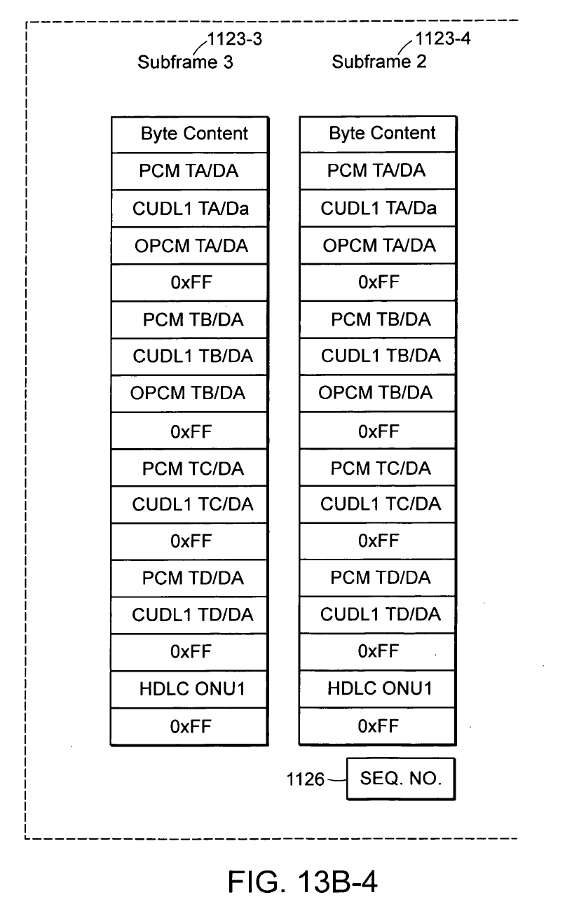

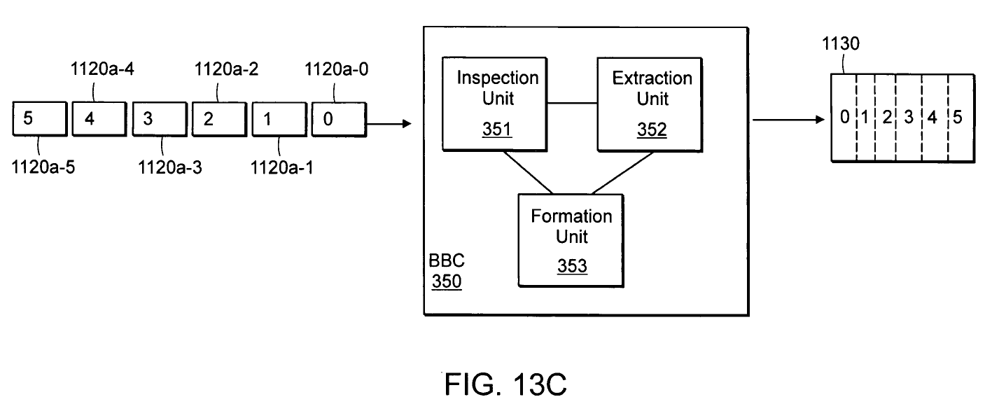

The columns 1301-1303, 1311-1313, 1304-1306 and bytes 1309 are described below in reference to FIG. 13B.

FIG. 13A illustrates an exemplary “downstream” flow of a superframe 1110 through a QOIU 260, resulting in multiple communications packets 11 20a-d transmitted to the multiple ONUs 300a-d. Based on the provisioned mode described above with respect to FIG. 12, the superframe 1110, having twenty-four subframes, is processed by the QOIU 260 into twenty-four packets 1120a-0 through 1120a-5 (collectively 1120a), 1120b-0 through 1120b-5 (collectively 1120b), 1120c-0 through 1 120c-5 (collectively 1120c), and 1120d-0 through 1120d-5 (collectively 1120d).

The QOIU 260 processes the superframe 1110 to repackage the superframe of data containing multiple subframes of data in known positions within the superframe into multiple communications packets. This may occur in a repackaging unit 261 of a QOIU 260.

An insertion unit 262 may insert a sequence indicator into the payload area of each packet to 1120a-d identify the position of the respective subframe within the superframe 1110. For example, the first four subframes of the superframe may be repackaged into four packets 1120a-0, 1120b-0, 1120c-0, and 1120d-0. Similarly, the next four subframes may be repackaged into four packets 1120a-1, 1120b-1, 1120c-1, and 1120d-1. In this example, the packets relating to superframe group DA are processed into six packets 1120a-0, 1120a-1, 1120a-2, 1120a-3, 1120a-4, and 1120a-5 and directed to ONU1 300a at a transmission rate λ This transmission rate may be a packet every 500 μsec. Each ONU 300a-d may collect its corresponding packet in a buffer (not shown). Through use of the sequence indicators, each ONU can repackage the six packets in a manner that preserves the position of the subframe data from the original superframe 1100.

The repackaging of subframes and insertion of sequence indicators may occur on a processor (not shown) executing software instructions. The software may be stored on any form of computer readable media, such as RAM, ROM, CD-ROM, and so forth, loaded by the processor, and executed. The processor may be a general purpose processor or an application specific processor. Alternatively, the repackaging and insertion of sequence numbers may be implemented in hardware, firmware, or a combination of software and either or both hardware or firmware.

FIG. 13B provides a detailed illustration of the superframe data contained in two exemplary packets processed by the QOIU 260. The first of the two packets, packet 1120a-0, contains data relating to superframe group DA from the first four subframes of the superframe 1110 of FIG. 12. Inspecting the first subframe of superframe 1110 of FIG. 12 along the time axis (horizontal of FIG. 12, vertical 1122-1 of FIG. 13B), the first byte content includes PCM data 1301 for group DA in timeslot TA, followed by CUDL data 1302 and DPCM data 1303 for the same ONU group and timeslot. This content is placed into the first packet, packet 1120a-0.

Continuing across the first subframe 1122-1 of the superframe 1110 (of FIG. 12), the subsequent byte content includes PCM data 1311 for group DB (corresponding to ONU 2) in timeslot TA, followed by CUDL data 1312 and DPCM data 1313 for the same ONU group and timeslot. This content is placed into the second of the two packets, packet 1120b-0. The QOIU 260 continues to build the packets 1120a-0 and 1120b-0 by extracting the data relating to each particular ONU for each subframe. For example, in PCM data 1304, CUDL data 1305, and DPCM data 1306 of the Superframe are organized into the first subframe 1122-1 of the first packet 1120a-0 processed by the QOIU 260. The second subframe 1122-2 of the same packet is built using the PCM data 1301, CUDL data 1302, and DPCM data 1303 from the second subframe of the superframe 1110 (of FIG. 12). As shown in FIG. 12, the data for each superframe group may be interleaved within the superframe 1110, and reorganized when repackaged into packets.

In the embodiment shown in FIG. 13B, the subframes of each packet are structured to include a second CUDL byte location after the DPCM data. As shown in both subframe 1 of the first packet 1120a-0 for ONU1 and subframe 1 of the first packet 1120b-0 for ONU2, an empty register OxFF follows the DPCM data. In subsequent subframes of packets, such as subframe 13 (not shown in FIG. 13B), additional CUDL bytes 1309 are allocated to ONU1, consistent with the data format of the superframe 1110 of FIG. 12.

In the example of FIG. 13B, the packets 1120a-0 and 1120b-0 contain four subframes of data 1122-1 through 1122-4 and 1123-1 through 1123-4, respectively. Each narrowband packet 1120a-0, 1120b-0 may also contain a standard Ethernet header. As packets 1120a, 1120b, etc. are processed from the superframe 1110, they are tagged with a sequence number (e.g., 1125, 1126, etc. in a payload area). Further, the source MAC address and narrowband VLAN ID may be loaded from an internal register, optionally preloaded by a control processor (not shown) in the QOIU 260. Other values in the header may be predefined in the narrowband packet format.

FIG. 13C illustrates the “downstream” flow of multiple narrowband packets 1120a-0, 1120a-1, 1120a-2, 1120a-3, 1120a-4 and 1120a-5 through a BBC 350. When the narrowband packets arrive at a BBC 350, an inspection unit 351 inspects the respective sequence indicators of the packets in the payload portion of the packets. An extraction unit 352 extracts multiple subframes of data contained in the packets, and then a formation unit 353 forms a frame of data 1130 from the multiple subframes of data using the sequence indicators from the sequence of packets 1120a-0, 1120a-1, 1120a-2, 1120a-3, 1120a-4 and 1120a-5 to maintain organization of the data. The inspection of packets, the extraction of multiple subframes of data, and the formation of a frame of data may occur in processor readable instructions executable by a processor.

Further, in other embodiments of the present invention, control bits corresponding to the multiple subframes of data may be extracted and directed to a processing unit, such as a narrowband control card (not shown). Embodiments of the present invention may provide forming multiple frames of data from the multiple subframes of data extracted from the packets. These multiple frames may be directed towards various destination nodes committed to the BBC 350 or may be transmitted through a buffer (not shown) in the QOIU 260 configured to queue multiple frames.

In the event that one of the packets 1120a-0, 1120a-1, 1120a-2, 1120a-3, 1120a-4 and 1120a-5 is lost in the transmission to the BBC 350, a loss of synchronization may occur. In this situation, the BBC 350 may form the frame of data using signaling bytes of other received packets from the sequence of packets and either reuse previous subframes of data or use a silence code in place of missing subframes of data. In doing so, the BBC 350 can maintain a call associated with a particular sequence of packets or alternatively drop the call in the event a next sequence of packets associated with the call dropping is received in a given length of time.

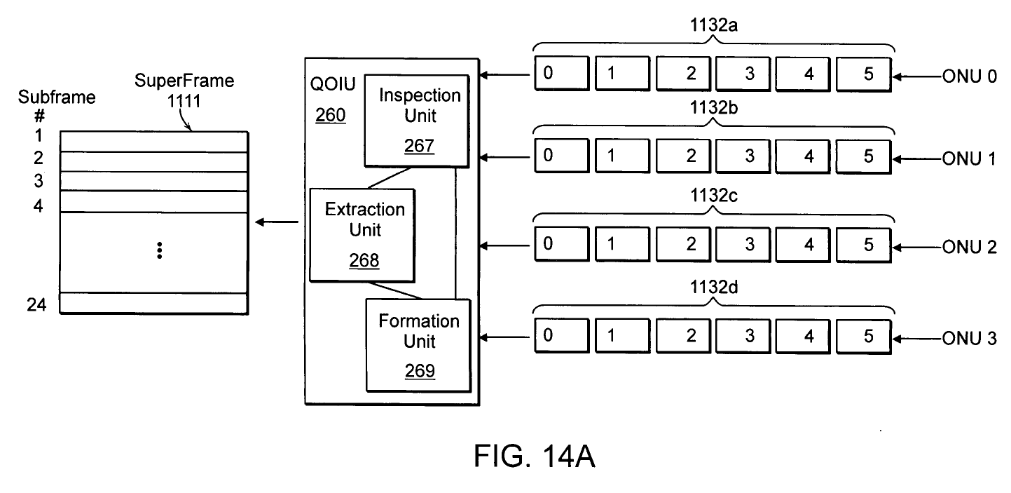

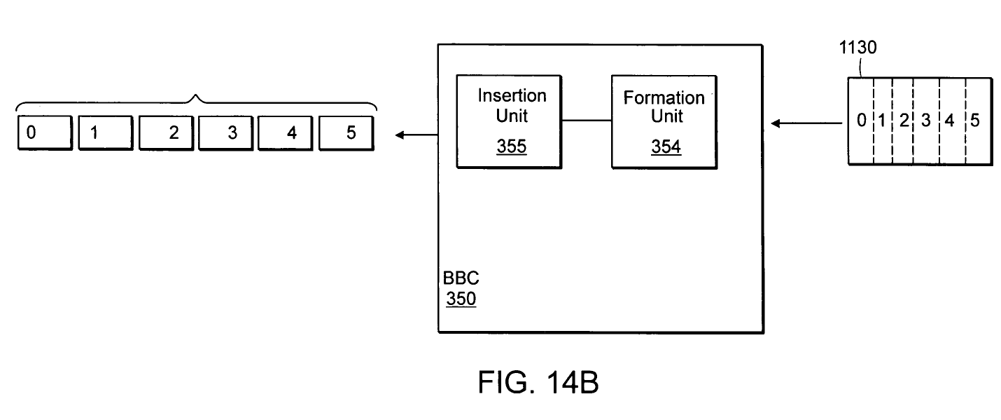

Similarly, according to embodiments of the present invention as shown in FIGS. 14A and 14B, communications between the QOIU 260 and the BBC 350 may occur in the “upstream” direction (i.e., from the BBC 350 to the QOIU 260). It should be apparent to those of ordinary skill in the art that similar principles of superframe processing can be applied in the upstream direction to provide narrowband traffic to the QOIU 260 in a manner that allows the formation of a superframe of data at the QOIU 260 using subframes contained in the upstream traffic. According to an embodiment of the present invention, a system or corresponding method provides narrowband communications across a communications link through processing packets into a superframe. In an embodiment, a node, such as an ONU, forms a sequence of packets containing subframes of data and inserts a sequence indicator in a payload portion of the packets. The sequence indicator may be used to position the respective subframes within a superframe of data formed at a second node, such as a Remote Data Terminal (RDT), receiving the sequence of packets. At the second node, sequence indicators in a payload portion of the packets may be inspected. The multiple subframes of data may be extracted along with corresponding command and control information. Using the sequence indicators, a superframe of data may be formed from the multiple subframes of data.

FIG. 14A is a block diagram of a QOIU 260 that includes an inspection unit 267, an extraction unit 268, and a formation unit 269 that may inspect respective sequence indicators in a payload portion of packets in a sequence of packets 1132a, 1132b, 1132c, 1132d (1132a . . . d), extract multiple subframes of data from the packets 1132a . . . d, and form a superframe 1111 of data with the multiple subframes of data based on the sequence indicators, respectively.

FIG. 14B is a block diagram of a BBC 350 that includes a formation unit 354, which may form multiple packets 1132 and of data containing multiple subframes of data, and an insertion unit 355, which may insert a sequence indicator in a payload portion of the packets 1132a used to position the respective subframes within a superframe formed at a node receiving the sequence of packets. As illustrated in this example embodiment, a narrowband signal 1130 arriving at the BBC 350 is formed into packets 0 through 5 1132a output by the BBC 350 for ease of reforming the superframe 1111.

In order to transmit the narrowband data from a QOIU 260 to a BBC 350, a network connection is first established. According to an embodiment of the present invention, a method or corresponding system may detect a network connection in a communications system, such as a narrowband communications system, using Virtual Local Area Network (VLAN) identification. In one embodiment, a first node transmits a message to a specific second node among a group of second nodes. The message from the first node may include a source Medium Access Control (MAC) address, a broadcast address, and a unique VLAN identification corresponding to a port on the first node. The specific second node may process the message and responsively transmit its own MAC address to the first node, along with the unique VLAN identification received in the original message from the first node. The first node may update locally or remotely stored information about the second node.

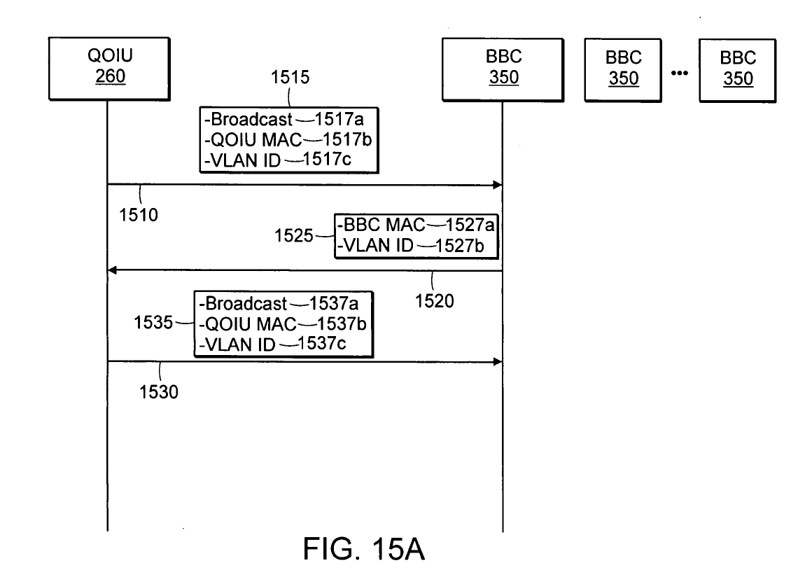

FIG. 15A is a signal diagram illustrating one embodiment of the present invention for detecting a network connection using VLAN identification. In order for the QOIU 260 to start narrowband communications with a BBC 350, a QOIU control processor (not shown) enables narrowband communications. In one implementation, an FPGA (shown in FIG. 6, as 2601) or other electronics device may monitor the narrowband enable bits in an internal control register. In this example, the control processor enables the narrowband process for each ONU once the QOIU 260 source MAC address is loaded into the FPGA registers, as well as the narrowband VLAN ID for the corresponding ONU port.

The QOIU 260 may synchronize its Data Processing Unit (DPU) interface to a DPU synchronization signal (not shown). In one embodiment, until the QOIU 260 receives the synchronization signal, no narrowband packets are constructed for transmission to the QOIU 260. During the time that the QOIU is waiting for ONU port(s) (not shown) to be enabled for narrowband communications, the DPU interface may support processing of a downstream superframe from the DPU.

To enable the narrowband communications between the QOIU 260 and a BBC 350 of an ONU, the QOIU 260 may generate and transmit 1510 a broadcast signal 1515 containing (i) a broadcast address 1517a as a destination address, (ii) the MAC address 1517b of the QOIU 260, and (iii) the port VLAN ID 1517c at a regular interval, such as approximately every 500 μsecs.

Upon receiving a narrowband packet (not shown), the BBC 350 checks the packet's destination MAC address. A broadcast destination MAC address or a destination MAC address that matches the BBC's MAC address may cause the BBC 350 to write the packet's source MAC address and VLAN ID into the narrowband packet's destination MAC address and VLAN ID registers (not shown). If the destination MAC address is not a broadcast address or is not the same as the BBC's address, the BBC 350 may discard the packet.

Once a valid narrowband packet is received by the BBC 350, the BBC transmits 1520 an upstream packet 1525 to the QOIU 260. The upstream packet 1525 may contain the MAC address 1527a of the BBC 350 and the VLAN ID 1527b (same as 1517c) assignment. Subsequently, packets 1535 from the QOIU 260 to the BBC 350 are transmitted 1530 with the BBC's MAC address 1537a (same as 1527a) identified as the destination address, the QOIU's MAC address 1537b (same as 1517b) identified as the source address, and the VLAN ID 1537c (same as 1517c) to identify the QOIU's port assignment for the particular BBC 350.

As illustrated in FIG. 15B, according to an embodiment of the present invention, a QOIU 260 may have port 2621, a memory 2626, a transmission unit 2622, and an update unit 2624. The memory may store a MAC address of the QOIU 260 and a unique VLAN identification that corresponds to the port 2621. The transmission unit 2622 is coupled to the port 2621 may be configured to transmit a message (not shown) across an optical connection or link to a BBC 350 connected to that port. In one embodiment, the message includes the MAC address, a broadcast address (since the MAC address of the BBC 350 is unknown), and the unique VLAN identification as discussed above. When the QOIU 260 receives a message from the BBC 350, the update unit 2606 may be configured to use the information in the message to update stored information about the BBC 350 in the memory 2626.

At the BBC 350, when an initial message is received at a port 3531, a parsing unit 3532 may parse the message to determine the MAC address of the QOIU 260 and the VLAN identification associated with the originating port 2621. A transmission unit 3534 may be configured to transmit a return message to the BBC 350, the return message including the BBC 350's MAC address, and the VLAN identification associated with the originating port 2621. A memory 3536 may store the MAC address of the BBC 350 and information it receives relating to the QOIU 260, such as a MAC address and VLAN identification.

It should be understood that the QOIU 260 may include a port, memory, and processor as illustrated in FIG. 6. The memory may store a MAC address of the QOIU 260 and a unique VLAN identification corresponding to the port. The processor may be coupled to the memory and the port. The processor may transmit a message that includes the MAC address, a broadcast address and a unique VLAN identification and also update stored information about a BBC 350, upon the receipt of a return message from the second node that includes a MAC address of that node.

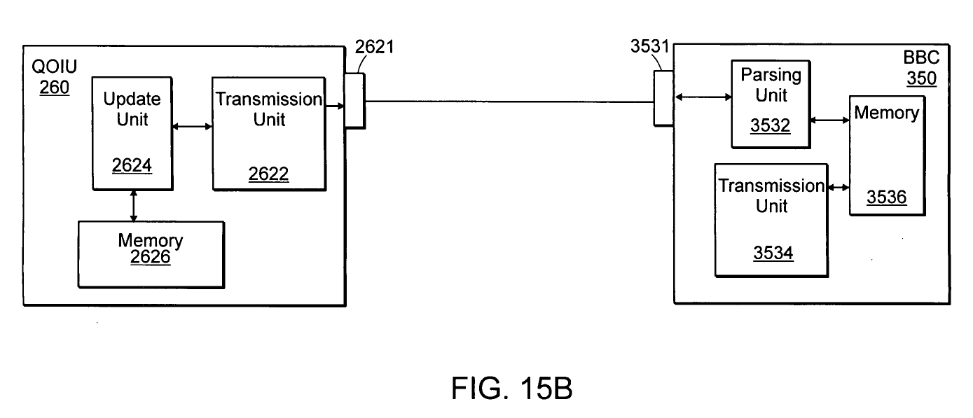

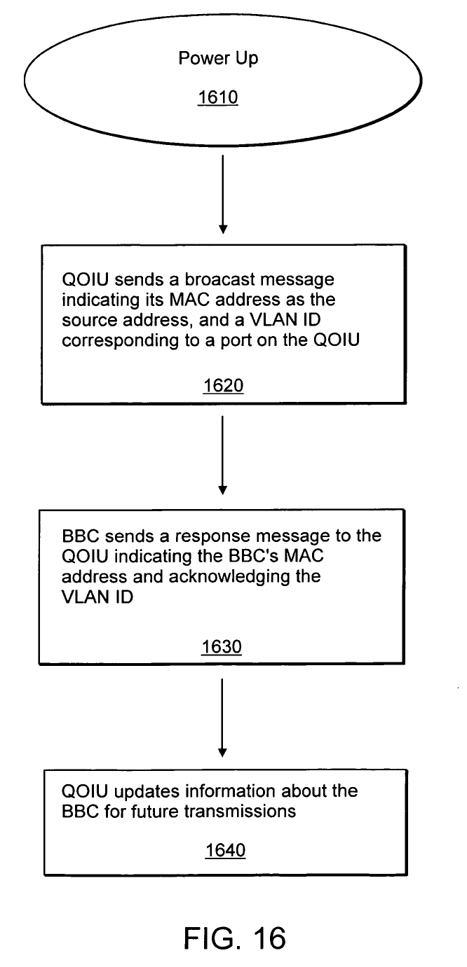

FIG. 16 provides a basic flow diagram of the detection of a network connection using VLAN identification according to an embodiment of the present invention. The connection initializes when either the QOIU 260 or the BBC 350 power(s) up 1610. In this embodiment, the QOIU 260 sends 1620 a broadcast message indicating (i) its MAC address as the source address and (ii) a VLAN ID corresponding to a port on the QOIU. The QOIU continues to generate and transmit this broadcast message until an upstream narrowband packet is received from the BBC. The BBC sends 1630 a response message to the QOIU indicating the BBC's MAC address and acknowledging the VLAN ID. The QOIU updates 1640 information in its database about the BBC for use in future transmissions. In some instances synchronization between the nodes may be lost, for example, if the unique VLAN ID is lost, the VLAN ID becomes invalid, or either MAC address becomes invalid. In embodiments of the present invention, if synchronization is lost between the nodes, messages may be retransmitted using the broadcast address to reestablish a connection.

Established digital loop carrier (DLC) systems may use the traditional telephony technique of passing 8 kHz network timing via optical or electrical links interconnecting the components of the system. These systems typically use phase locked loops (PLLs) having voltage controlled crystal oscillators (VCXOs). Lower voltages used for digital design has tightened the specifications on off-the-shelf VCXOs. A minimum “pull” range (i.e., a parameter used to define the maximum frequency pull from the actual operating frequency under a given set of operating conditions) has decreased as power rails have dropped. Frequencies that the VCXOs are required to generate have gone higher to track higher link rates. This increases board layout complexity, as shorter runs are required to ensure a clean clock.

Embodiments of present invention provide an opportunity to use a different timing architecture. An example IPTV system of the present invention may be dominated by transmission of frame-based data. Frame-based data platforms use asynchronous bidirectional links. Data recovery occurs by using a clock/data recovery (CDR) circuit that has a local crystal oscillator as a timing reference. The data is sampled and retimed to a local clock domain. This local crystal oscillator may also be used to source the outgoing link.

According to an embodiment of the present invention, a method or corresponding system generates a network quality clock signal in a communications system by synthesizing a first clock signal based on arrival rate of packets transmitted via a network link at a rate according to a network clock. The system then synthesizes a second clock signal based on the first clock signal. The second clock signal may have a frequency substantially the same as the network clock. In embodiments of the present invention, the first clock signal may be synthesized by using a phase locked loop, such as a digital PLL configured to synchronize with the arrival rate of narrowband packets. This phase locked loop may include a proportional and integral controller configured to integrate frequency error and control overshoot of the first clock signal. The arrival rate of the packets may be detected by an optical detection module. The second clock signal may also be synthesized using a phase locked loop based on the first clock signal. In embodiments of the present invention, the second phase locked loop is an analog PLL. The second clock signal may be used for narrowband data services and time division multiplexing communications networks.

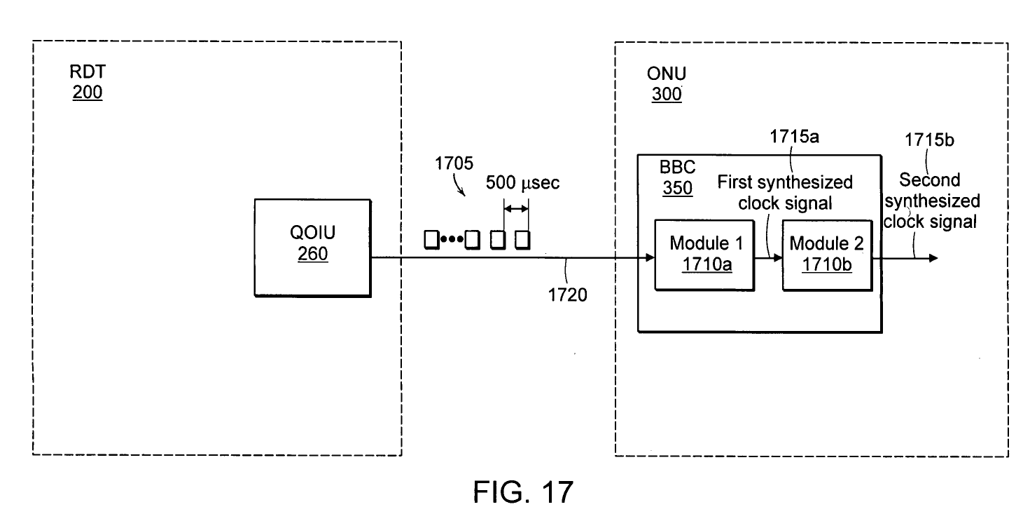

FIG. 17 is a block diagram illustrating an embodiment of the present invention within the IPTV system. A QOIU 260 in a Remote Digital Terminal 200 (RDT) provides narrowband communications to a BBC 350 in an Optical Networking Unit 300 (ONU). A first module 1710a synthesizes a first clock signal 1715a based on arrival rate (e.g., every 500 μsec) of packets 1705 transmitted via a network link 1720 at a rate according to a network clock (not shown). A second module 1710breceives the first clock signal 1715a and synthesizes a second clock signal 1715b, based on the first clock signal. The second clock signal 1715b may remove jitter created by the first module 1710a, by the QOIU 260, or communications path 1720 and provide a frequency substantially the same as the network clock.

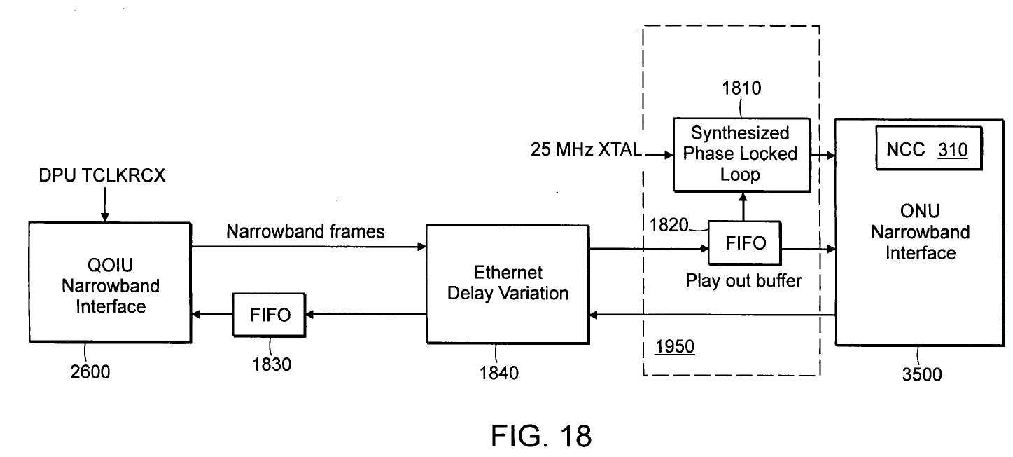

FIG. 18 is a high level diagram illustrating an embodiment of the present invention for generating a network quality clock signal. Use of local clock demands on the QOIU 260 and the BBC 350 may require that the 8 kHz network timing be available at the BBC 350. Because of the optical communications link between the QOIU 260 and the BBC 350 with packet-based communications using non-synchronous communications protocols, the network timing is transferred by a different means than in cases the communications links use synchronous communications protocols. Thus, the local clock is synthesized to provide the network quality clock signal.

As shown in FIG. 18, the BBC narrowband interface system 1950 is designed in such a way as to attenuate jitter of packet arrival, upon which an output clock is based, that appears on the output clock. An embodiment of system 1950 contains both a first in-first-out (FIFO) buffer 1820 and a system of PLLs 1810.

In embodiments of the present invention, a narrowband interface 2600 on the QOIU transmits the narrowband information to the BBC narrowband interface 1950 every 500 μsecs on both the QOIU 260 and the BBC 350. The PLLs 1810 and FIFO 1820 of the BBC narrowband interface 1950 provide the narrowband data along with a clock signal to the ONU narrowband interface 3500 in a narrowband common card (NCC) 370.

In one embodiment, sequence number imbedded in the narrowband packet allows logic to insert a duplicate of the previous packet's PCM into a FIFO 1820. This prevents the system of PLLs 1810 from changing the digitally controlled oscillator (DCO) (not shown) output frequency in the event that a limited number of packets are lost due to errors caused by Ethernet delay variation 1840. Duplication of the previous PCM minimizes a voice frequency (VF) customer perceived noise. In some embodiments of the present invention, a FIFO 1830 may also be included to buffer upstream data, even though the upstream data received by the QOIU narrowband interface 2600 is looped timed to the backplane timing.

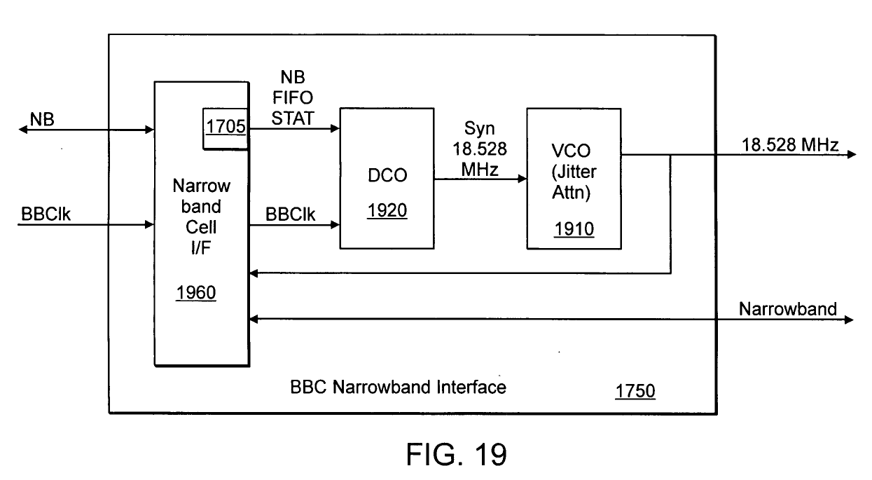

FIG. 19 illustrates a more detailed diagram of the BBC narrowband interface 1950 in an ONU. The BBC narrowband interface 1950 uses a digitally controlled oscillator (DCO) 1920 and a voltage controlled oscillator (VCO) 1910. The narrowband cell interface 1960 receives the narrowband signals and the BBC clock signal. The narrowband cell interface 1960 buffers the incoming packets in its FIFO buffer 1720. The narrowband cell interface 1960 sends the local BBC clock signal (BBClk) and a FIFO status signal (NB FIFO STAT) to the DCO 1920, which generates a clock output based on the frequency of the incoming narrowband packets to the BBC.

In one embodiment, the edge jitter caused by the DCO 1920 output is minimized by using an analog phase locked loop 1910 that uses a low power voltage controlled oscillator (VCO) that provides the required jitter attenuation. The BBC narrowband PLL recovery range allows for an approximation of a network Stratum clock.

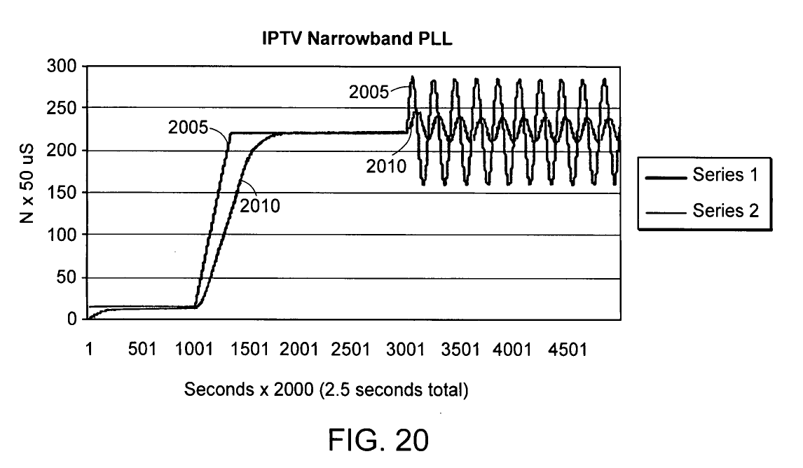

FIG. 20 illustrates the reduction of delay jitter as provided by use of the DCO 1920 (FIG. 19) in the example system of the present invention. A first curve 2005 is a simulation output that represents jitter of a clock signal produced by a model of a clock synthesizer found in systems that do not synthesize a system clock, as described in reference to FIGS. 16 and 17. A second curve 2010 is a simulation output that represents jitter of a clock signal produced by a model of a clock synthesizer as described in reference to FIGS. 16 and 17.

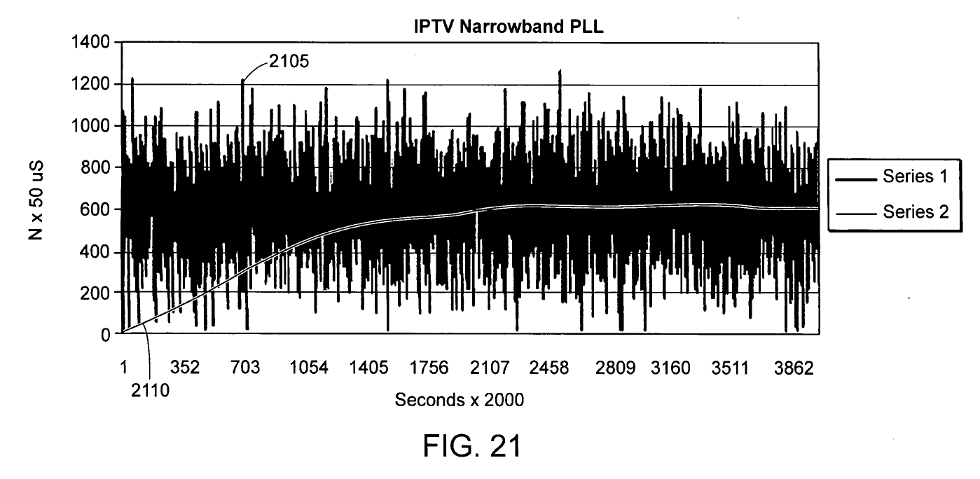

FIG. 21 illustrates the reduction in edge jitter as provided by the use of the VCO 1910 (FIG. 19) in the system of the present invention. A “noisy” curve 2105 is a simulation output that represents narrowband packets 1120a-d (FIG. 13A) received by respective ONUs 300a-d every 500 μsecs. A “smooth” curve 2110 is a simulation output that represents a twice synthesized clock signal as described in reference to FIGS. 17 and 18. The twice synthesized clock signal may be generated by at least one synthesizer with a Proportional-Integral (PI) controller, so the curve 2110 does not overshoot to any appreciable level (i.e., the synthesized clock signal reaches its operating frequency without going much higher in frequency). This level of stability may be useful to ensure quality sound output for a listener at a receiving end of the narrowband portion of the system described herein.

It should be apparent to those of ordinary skill in the art that methods involved in the present invention may be embodied in a computer program product that includes a computer usable medium. For example, such a computer usable medium may consist of a read-only memory device, such as a CD-ROM disk or convention ROM devices, or a random access memory, such as a hard drive device or a computer diskette, having a computer readable program code stored thereon.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of detecting a network connection, comprising:
transmitting a message from a first node to a specific second node among a group of second nodes, the message including a Medium Access Control (MAC) address of the first node, a broadcast address, and a unique Virtual Local Area Network (VLAN) identification corresponding to a port on the first node;
transmitting to the first node, from the specific second node, a MAC address of the specific second node and the unique (VLAN) identification received in the message; and
updating stored information about the specific second node in the first node with the MAC address of the specific second node.

2. A method of claim 1 further comprising using the MAC address of the specific second node in place of the broadcast address in further messages from the first node to the specific second node.

3. A method of claim 2 further comprising retransmitting messages with the broadcast address on further messages if synchronization is lost between the first node and the specific second node.

4. A method of claim 3 further including considering synchronization lost in an event (i) the unique VLAN identification is lost, (ii) the VLAN identification is invalid, or (iii) either MAC address is invalid.

5. A method of claim 1 wherein transmitting the message from the first node to the specific second node includes transmitting the message via narrowband communications.

6. A system for detecting a network connection, comprising:
a first node including (i) a first port, (ii) a memory, (iii) a transmission unit coupled to the first port and configured to transmit a first message, the first message including a Medium Access Control (MAC) address of the first node, a broadcast address, and a unique Virtual Local Area Network (VLAN) identification corresponding to the first port on the first node, and (iv) an update unit, configured to update stored information about a second node in the memory upon receipt of a second message from the second node;
a specific second node in a group of second nodes, the specific second node including (i) a second port, (ii) a receive unit configured to receive the first message, (iii) a transmission unit configured to transmit a second message to the first node, the second message including a MAC address of the specific second node and the unique VLAN identification received in the first message.

7. A system of claim 6 wherein the transmission unit of the first node is further configured to use the MAC address of the specific second node in place of the broadcast address in further messages from the first node to the specific second node.

8. A system of claim 7 wherein the transmission unit of the first node is further configured to retransmit messages with a broadcast address on further messages if synchronization is lost between the first node and the specific second node.

9. A system of claim 8 wherein the transmission unit of either first node or the specific second node is configured to consider synchronization lost in an event (i) the VLAN identification is lost, (ii) the VLAN identification is invalid, or (iii) either MAC address is invalid.

10. A system of claim 6 wherein the first and second nodes communicate the first and second messages via narrowband communications.

11. A method of detecting a network connection at a first node, comprising:
transmitting a message to a specific second node among a group of second nodes, the message including a Medium Access Control (MAC) address of the first node, a broadcast address, and a unique Virtual Local Area Network (VLAN) identification corresponding to a port; and
updating stored information about the specific second node upon receipt of a return message from the specific second node, the return message including a MAC address of the specific second node and the VLAN identification.

12. A method of claim 11 further comprising using the MAC address of the specific second node in place of the broadcast address in further messages from the first node to the specific second node.

13. A method of claim 12 further comprising retransmitting messages with the broadcast address on further messages if synchronization is lost between the first node and the specific second node.

14. A method of claim 13 further including considering synchronization lost in an event (i) the unique VLAN identification is lost, (ii) the VLAN identification is invalid, or (iii) either MAC address is invalid.

15. A method of claim 11 wherein transmitting the message includes transmitting the message via narrowband communications.

16. A first node in a network, comprising:
a port on a first node in a network;
memory that stores a Medium Access Control (MAC) address of the first node and a unique Virtual Local Area Network (VLAN) identification corresponding to the port;
a transmission unit coupled to the port and configured to transmit a first message, the first message including a Medium Access Control (MAC) address of the first node, a broadcast address, and a unique Virtual Local Area Network (VLAN) identification corresponding to the port on the first node, and;
an update unit, configured to update stored information about a second node in the memory upon receipt of a second message from the second node.

17. A first node of claim 16 wherein the transmission unit is further configured to use the MAC address of the second node in place of the broadcast address in further messages from the first node to the second node.

18. A node of claim 17 wherein the transmission unit is further configured to retransmit messages with a broadcast address on further messages if synchronization is lost between the first and second nodes.

19. A node of claim 18 wherein the transmission unit is further configured to consider synchronization lost in an event (i) the VLAN identification is lost, (ii) the VLAN identification is invalid, or (iii) either MAC address is invalid.

20. A node of claim 16 wherein the message is a narrowband communication.

21. A method of detecting a network connection at a second node, comprising:
parsing at a second node a message from a first node to determine a Medium Access Control (MAC) address of the first node and a unique Virtual Local Area Network (VLAN) identification corresponding to a port on the first node; and
transmitting a return message to the port on the first node including a MAC address of the second node and the VLAN identification corresponding to the port on the first node.

22. A method of claim 21 further comprising parsing further messages from the first node, the messages containing the MAC address of the second node in place of the broadcast address.

23. A method of claim 22 further comprising reparsing messages with the broadcast address on further messages if synchronization is lost between the first node and the second node.

24. A method of claim 23 further including considering synchronization lost in an event (i) the unique VLAN identification is lost, (ii) the VLAN identification is invalid, or (iii) either MAC address is invalid.

25. A method of claim 21 wherein receiving a message from the first node occurs through narrowband communications.

26. A second node in a network, comprising:
a port on a second node in a network;
memory that stores a Medium Access Control (MAC) address of the second node and a unique Virtual Local Area Network (VLAN) identification corresponding to a first port of a first node;
a parsing unit coupled to the port and configured to parse a message from a first node to determine a Medium Access Control (MAC) address of the first node and a unique Virtual Local Area Network (VLAN) identification corresponding to a port on the first node; and
a transmission unit configured to transmit a return message to the port on the first node, the return message including a MAC address of the second node and the VLAN identification corresponding to the port on the first node.

27. A system of claim 26 wherein the parsing unit is further configured to parse messages from the first node containing the MAC address of the second node in place of the broadcast address.

28. A system of claim 27 wherein the parsing unit is further configured to reparse messages with the broadcast address on further messages if synchronization is lost between the first node and the second node.

29. A system of claim 28 wherein the transmission unit is further configured to consider synchronization lost in an event (i) the VLAN identification is lost, (ii) the VLAN identification is invalid, or (iii) either MAC address is invalid.

30. A node of claim 26 wherein the message is a narrowband communication.
